(19) United States
(12) Patent Application Publication
(10) Pub. No.: US 2026/0339916 A1
(43) Pub. Date: Oct. 29, 2026

(54) HYBRID EXECUTION FOR DATAFRAME OPERATIONS

(71) Applicant: Snowflake Inc., Bozeman, MT (US)

(72) Inventors: John Victor Kew, Seattle, WA (US); Jung Lin Lee, Bellevue, WA (US); Devin Petersohn, Liberty, MO (US); Jonathan Shi, Mountain View, CA (US); Mahesh Shankar Vashishtha, Los Angeles, CA (US)

(21) Appl. No.: 19/189,677

(22) Filed: Apr. 25, 2025

(51) Int. Cl. G06F 16/22

(52) U.S. Cl. CPC G06F 16/2282

(57) ABSTRACT

Dataframe operations can be processed in a hybrid execution environment. Instructions to perform a dataframe operation are received and analyzed for characteristics of the dataframe operations. A first engine is selected to execute a first section of the dataframe operation based on the characteristics. The first section of the dataframe operation is executed on the first engine.

### TECHNICAL FIELD

The present disclosure generally relates to data platforms and databases and, more specifically, to hybrid execution frameworks for dataframe workloads.

### BACKGROUND

Network-based database systems can be provided through a cloud data platform, which allows organizations, customers, and users to store, manage, and retrieve data from the cloud. Cloud data platforms are widely used for data storage and data access in computing and communication contexts. With respect to architecture, a cloud data platform could be a network-based data platform (e.g., a cloud-based data platform), another type of architecture, or some combination thereof. With respect to type of data processing, a cloud data platform could implement online analytical processing (OLAP), online transactional processing (OLTP), a combination of the two, another type of data processing, or some combination thereof. Moreover, a cloud data platform could be or include a relational database management system (RDBMS) or one or more other types of database management systems.

In an implementation of a cloud data platform, a given database (e.g., a database maintained for a customer account) can reside as an object (e.g., within a customer account) that can also include one or more other objects (e.g., users, roles, privileges, and/or the like). Furthermore, a given object, such as a database, can itself contain one or more objects such as schemas, tables, materialized views, and/or the like. A given table can be organized as a collection of records (e.g., rows) that each include a plurality of attributes (e.g., columns). In some implementations, database data can be physically stored across multiple storage units, which may be referred to as files, blocks, partitions, micro-partitions, and/or by one or more other names. In many cases, a database on a cloud data platform serves as a backend for one or more applications that are executing on one or more application servers.

### BRIEF DESCRIPTION OF THE SEVERAL VIEWS OF THE DRAWINGS

The present disclosure will be apparent from the following more particular description of examples of embodiments of the technology, as illustrated in the accompanying drawings. The drawings are not necessarily to scale, emphasis instead being placed upon illustrating embodiments of the present disclosure. In the drawings, like numerals may describe similar components in different views. Like numerals having different letter suffixes may represent different instances of similar components. Various ones of the appended drawings merely illustrate example embodiments of the present disclosure and should not be considered as limiting its scope.

FIG. 1 illustrates an example computing environment in which a cloud data platform, in communication with a cloud storage platform, can implement dataframe functionality, according to some example embodiments.

FIG. 2 is a block diagram illustrating components of a compute service manager, according to some example embodiments.

FIG. 3 is a block diagram illustrating components of an execution platform, according to some example embodiments.

FIG. 4 is a computing environment conceptually illustrating an example software architecture executing a user defined function (UDF) by a process running on a given execution node of the execution platform, according to some example embodiments.

FIG. 5 is a block diagram of a hybrid execution framework, according to some example embodiments.

FIG. 6 is a block diagram of a hybrid execution framework, according to some example embodiments.

FIG. 7 shows a flowchart illustrating a method for executing a dataframe operation across different engines, according to some example embodiments.

FIG. 8 shows examples of source data for decisions, according to some example embodiments.

FIGS. 9A-9B show a flowchart illustrating a method for a decision tree for switching execution engines for dataframe operations, according to some example embodiments.

FIG. 10 shows a flowchart illustrating a method for selecting a target engine based on cost estimates during a potential engine switch decision process, according to some example embodiments.

FIG. 11 illustrates an example diagrammatic representation of a machine in the form of a computer system within which a set of instructions may be executed for causing the machine to perform any one or more of the methodologies discussed herein, according to some example embodiments.

### DETAILED DESCRIPTION

The description that follows includes systems, methods, techniques, instruction sequences, and computing machine program products that embody illustrative embodiments of the disclosure. In the following description, for the purposes of explanation, numerous specific details are set forth in order to provide an understanding of various embodiments of the inventive subject matter. It will be evident, however, to those skilled in the art, that embodiments of the inventive subject matter may be practiced without these specific details. In general, well-known instruction instances, protocols, structures, and techniques are not necessarily shown in detail. For the purposes of this description, the phrase “cloud data platform” may be referred to as and used interchangeably with the phrases “a network-based database system,” “a database system,” or merely “a platform.”

Disclosed herein are various examples of systems and methods for providing a developer framework and programming environment that integrates application development capabilities directly into a cloud data platform, enabling developers to author scripts and applications utilizing common programming languages that can interface with the cloud data warehouse tables, execute queries, invoke functions, and similar operations.

The developer framework and programming environment brings deeply integrated, dataframe-style programming and open-source software (OSS) compatible APIs to the languages that users (e.g., data practitioners) like to use. It provides familiar A Pls for various data centric tasks, including data preparation, cleansing, preprocessing, model training, deployments tasks, machine learning, and the like. A dataframe is a two-dimensional, size-mutable, tabular data structure used in data analysis and data science, particularly within programming languages like Python and R. A dataframe can include of rows and columns, where each column can hold data of a specific type, such as integers, strings, or floating-point numbers. Both rows and columns can have labels (indexes and column names), enabling easy data access and manipulation. dataframes provide an intuitive interface for manipulating and analyzing structured data, allowing operations such as filtering, aggregating, and joining data, as well as performing statistical analyses and visualizations. dataframes are commonly provided by libraries such as Pandas in Python, Spark in Scala and Python, and data.table in R.

Additional example embodiments can be performed in a sandbox environment. In computer security, a sandbox (e.g., sandbox environment) is a security mechanism for separating running programs, usually to prevent system failures or prevent exploitation of software vulnerabilities. A sandbox can be used to execute untested or untrusted packages, programs, functions, or code, possibly from unverified or untrusted third parties, suppliers, users, or websites, without risking harm to the host machine or operating system. A sandbox can provide a tightly controlled set of resources for guest programs to run in, such as storage and memory scratch space. Network access, the ability to inspect the host system or read from input devices can be disallowed or restricted. UDFs typically can run in a sandbox environment. The optional sandbox environment provides important security isolation for untrusted code execution. It restricts access to resources like storage, memory, and network connectivity to contain untrusted code. Policies can enforce permissions, resource limits, auditing, and multi-tenant isolation when running User Defined Functions (UDFs) from different users. The developer framework delivers a unified interface to the cloud data warehouse for languages like Python and Structured Query Language (SQL). Some example embodiments described herein can be run within a sandbox environment, which is described and depicted in more detail below.

In the realm of data processing and analytics, the efficient execution of dataframe operations is growing in terms of importance, particularly as data volumes continue to grow exponentially. dataframes, which are in-memory representations of tabular data, are widely used in programming languages such as Python and R for data manipulation and analysis. However, the execution of dataframe operations across different systems and engines presents significant challenges, especially when considering the diverse workload characteristics and backend capabilities. The need for seamless integration and execution of dataframe operations across various platforms has become increasingly important, as users demand high performance and interactivity in their data workflows.

Existing solutions for executing dataframe operations often fall short in addressing these challenges. Traditional approaches, such as federated queries, allow for data movement between different SQL engines to optimize query plans. However, these methods are relatively primitive. Moreover, Pandas are typically limited to single-machine execution, leading to scalability issues that force users to either scale down their data or port existing code to other large-data frameworks.

The hybrid execution techniques for dataframe operations described herein address the limitations of existing methods by automatically determining the optimal execution engine based on a variety of characteristics. The hybrid execution techniques can leverage a rule engine that gathers statistics and metadata related to current operations within the dataframe workflow. By employing a cost function, the system can also evaluate the cost of running operations on each engine backend, facilitating automatic engine switching to optimize performance. This approach not only enhances the execution of dataframe operations by selecting the most suitable engine but also provides a unified interface that abstracts the complexity of engine selection from the user. As a result, users can seamlessly execute their dataframe operations without manually moving data or switching between different engine backends, thereby improving efficiency and user experience while maintaining data security.

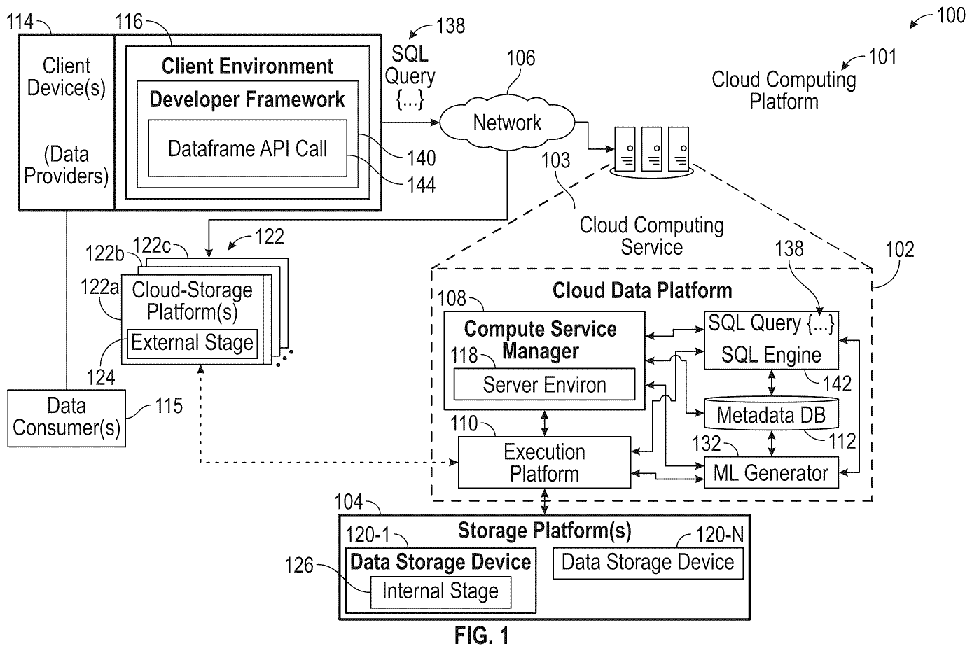

FIG. 1 is an example computing environment 100 illustrating a cloud data platform 102 including a developer framework and programming environment that integrates application development functionality with dataframe capabilities, in accordance with some embodiments of the present disclosure.

To avoid obscuring the inventive subject matter with unnecessary detail, various functional components that are not germane to conveying an understanding of the inventive subject matter have been omitted from FIG. 1. However, a skilled artisan will readily recognize that various additional functional components may be included as part of the computing environment 100 to facilitate additional functionality that is not specifically described herein. In other embodiments, the computing environment may comprise another type of cloud data platform or a cloud data platform. For example, in some aspects, the computing environment 100 may include a cloud computing platform 101 with the cloud data platform 102 and a storage platform 104 (also referred to as a cloud storage platform). The cloud computing platform 101 provides computing resources and storage resources that can be acquired (purchased) or leased and configured to execute applications and store data.

The cloud computing platform 101 may host a cloud computing service 103 that facilitates storage of data on the cloud computing platform 101 (e.g., data management, access, etc.) and analysis functions (e.g., SQL queries, analysis, etc.), as well as other processing capabilities. The cloud computing platform 101 may include a three-tier architecture: data storage (e.g., storage platform 104 and storage platforms 122), an execution platform 110 (e.g., providing query processing), and a compute service manager 108 providing cloud services including services associated with the disclosed functionalities.

In the present disclosure, a cloud data platform 102 (e.g., database system, distributed database system) can support data storage for one or more different organizations (e.g., customer organizations, which can be individual companies or business entities), where each individual organization can have one or more accounts (e.g., customer accounts) associated with the individual organizations, and each account can have one or more users (e.g., unique usernames or logins with associated authentication information). In an example implementation, a cloud data platform includes one or more databases that are maintained on behalf of a customer account (e.g., accounts of one or more data providers). Data can be shared between a provider account, which owns the data, and a consumer account (e.g., receiver account, data consumer, etc.), which can have access to the data using two-way secure data sharing between private and public clouds according to a relationship establishment procedure (e.g., a handshake) to ensure a trust relationship is established between the provider and the consumer. Users or executing processes that are associated with a given customer account can, via one or more types of clients, be able to cause data to be ingested into the database, and can also be able to manipulate the data, add additional data, remove data, run queries against the data, generate views of the data, and so forth. Moreover, it is often the case that data providers are direct customers of a cloud data platform. As examples, data providers can provide one or more types of data, such as financial data (e.g., stock prices), weather data, pandemic test results, vaccination levels, and/or the like. These data providers, using client device(s) 114, typically have one or more customers of their own that consume the data; these entities are referred to in the present disclosure as “data consumer(s) 115” or simply “consumers.” In some examples, a data consumer might be a trading house that consumes financial data from a data provider.

Additionally, an individual account can have one or more users that are designated as an administrator for the individual account. An individual account of an organization can be associated with a specific cloud platform (e.g., cloud-storage platform, such as such as AMAZON WEB SERVICES™ (AWS™), MICROSOFT® AZURE®, GOOGLE CLOUD PLATFORM™), one or more servers or data centers servicing a specific region (e.g., geographic regions such as North America, South America, Europe, Middles East, Asia, the Pacific, etc.), a specific version of a data platform, or a combination thereof. A user of an individual account can be unique to the account. Additionally, a cloud data platform can use an organization data object to link accounts associated with (e.g., owned by) an organization, which can facilitate management of objects associated with the organization, account management, billing, replication, failover/failback, data sharing within the organization, and the like.

In a typical implementation, a cloud data platform 102 includes one or more databases that are maintained on behalf of a user account. The cloud data platform 102 may include one or more databases that are respectively maintained in association with any number of user accounts (e.g., accounts of one or more data providers or other types of users), as well as one or more databases associated with a system account (e.g., an administrative account) of the cloud data platform 102, one or more other databases used for administrative purposes, and/or one or more other databases that are maintained in association with one or more other organizations and/or for any other purposes. A cloud data platform 102 may also store metadata (e.g., account object metadata) in metadata database(s) 112 in association with the data platform in general and in association with, for example, particular databases and/or particular user accounts as well. Users and/or executing processes that are associated with a given user account may, via one or more types of clients (e.g., customer environment), be able to cause data to be ingested into the database, and may also be able to manipulate the data, add additional data, remove data, run queries against the data, generate views of the data, and so forth.

It is often the case that organizations that are users of a given data platform also maintain data storage (e.g., a data lake) that is external to the data platform (e.g., one or more external storage locations, external stage 124). For example, a company could be a user of a particular data platform and also separately maintain storage of any number of files—be they unstructured files, semi-structured files, structured files, and/or files of one or more other types—on, as examples, one or more of their servers and/or on one or more cloud-storage platforms such as AMAZON WEB SERVICES™ (AWS™), MICROSOFT® AZURE®, GOOGLE CLOUD PLATFORM™, and/or the like. The user's servers and cloud-storage platforms are both examples of what a given user could use as what is referred to herein as an external storage location. The cloud computing platform 101 could also use a cloud storage platform 104 as what is referred to herein as an internal storage (e.g., internal stage 126) location concerning the data platform.

From the perspective of the cloud data platform 102 of the cloud computing platform 101, one or more files that are stored at one or more storage locations are referred to herein as being organized into one or more of what is referred to herein as either “internal stages 126” or “external stages 124.” Internal stages 126 are stages that correspond to data storage at one or more internal storage locations, and internal stages 124 are stages that correspond to data storage at one or more external storage locations. In this regard, external files can be stored in internal stages 124 at one or more external storage locations cloud-storage platforms 122, and internal files can be stored in internal stages 126 at one or more internal storage locations (e.g., cloud storage platform 104), which can include servers managed and controlled by the same organization (e.g., company) that manages and controls the cloud data platform 102, and which can instead or in addition include data-storage resources operated by a storage provider (e.g., a cloud-storage platform) that is used by the data platform for its “internal” storage. The internal storage of a data platform is also referred to herein as the “storage platform” of the data platform. It is further noted that a given external file that a given user stores at a given external storage location may or may not be stored in an external stage in the external storage location; in some data-platform implementations, it is a user's choice whether to create one or more external stages (e.g., one or more external-stage objects) in the user's data-platform account as an organizational and functional construct for conveniently interacting via the data platform with one or more external files. External stage 124 in the cloud data platform 102 allows customers (e.g., data providers, data consumers, engineers, users, etc.) to load cloud data platform tables from and unload tables into object buckets under the customers' cloud provider accounts. The object bucket can be on the same cloud provider as where the cloud data platform 102 is deployed or on a different cloud provider, as the word “external” highlights the fact that the object bucket resides under the customers' cloud provider accounts.

As shown, the cloud data platform 102 of the cloud computing platform 101 is in communication with the storage platforms 104 and 122 (e.g., AWS®, Microsoft Azure Blob Storage®, or Google Cloud Storage). The cloud data platform 102 is a network-based system used for reporting and analysis of integrated data from one or more disparate sources including one or more storage locations within the storage platform 104. The storage platform 104 comprises a plurality of computing machines and provides on-demand computer system resources such as data storage and computing power to the cloud data platform 102.

The cloud data platform 102 comprises a compute service manager 108, an execution platform 110, and one or more metadata databases 112. The cloud data platform 102 hosts and provides data reporting and analysis services to multiple client accounts.

The compute service manager 108 coordinates and manages operations of the cloud data platform 102. The compute service manager 108 also performs query optimization and compilation as well as managing clusters of computing services that provide compute resources (also referred to as “virtual warehouses”). The compute service manager 108 can support any number of client accounts such as end-users providing data storage and retrieval requests, system administrators managing the systems and methods described herein, and other components/devices that interact with compute service manager 108.

The compute service manager 108 is also in communication with a client device(s) 114. The client device(s) 114 correspond to a user of one of the multiple client accounts (e.g., data provider accounts) supported by the cloud data platform 102. A user may utilize the client device 114 to submit data storage, retrieval, and analysis requests to the compute service manager 108. Client device 114 (also referred to as a user device) may include one or more of a laptop computer, a desktop computer, a mobile phone (e.g., a smartphone), a tablet computer, a cloud-hosted computer, cloud-hosted serverless processes, or other computing processes or devices that may be used to access services provided by the cloud computing platform 101 (e.g., cloud computing service 103) by way of a network 106, such as the Internet or a private network. The developer can write code (e.g., developer framework and programming environment Python code) in a local development environment of the client device(s) 114, a Python worksheet in the query user interface of the cloud data platform, a client application, client environment 116, or the like. For example, a developer (e.g., a data engineer of a data provider using client environment 116 on client device(s) 114) can set up the user's preferred development environment and establish a session to interact with the cloud data platform 102. For example, example embodiments can include a client environment (e.g., client component), such as a cloud data platform Java Database Connectivity (JDBC) or cloud data platform Open Database Connectivity (ODBC) client used to connect to the cloud computing platform 101, such as any of the cloud data platform system, components, facilities, and/or applications.

A client, such as a presentation client, could reside on a client-side computing device on which the client interacts with one or more client-side applications and on which the client makes use of certain client-side-system resources such as network interfaces, user interfaces, memory (e.g., random access memory (RAM)), and/or the like. The client environment 116 can include a developer framework 140 to form a user-friendly abstraction layer over underlying data and uses a dataframe API call 144 to transmit a query, such as SQL query 138 that includes dynamic pivot functionality, transmitted to the cloud data platform 102 via network 106.

According to example embodiments, the cloud data platform 102 is operatively connected to a developer framework and programming environment (also referred to throughout the disclosure as the “developer framework” or simply, “the framework”) that enables data engineers, data scientists, developers, or other users to build complex data pipelines and processes using common programming languages, such as Python, Scala, Java, or the like. The developer framework 140 allows developers to directly interact with the cloud data platform 102 to run queries, such as SQL query 138, and operations without having to extract and move data out of the platform. The developer framework 140 provides libraries and runtimes to securely execute non-SQL code within the cloud data platform 102. With the developer framework 140, developers can construct dataframe queries and transformations programmatically in their code via the client environment 116. The developer framework 140 dynamically generates the underlying SQL code to execute against the cloud data platform 102 in a robust and schema-driven manner. The developer framework 140 simplifies building complex pipelines and provides developers direct data access, in some examples, avoiding extract, transform, and load (ETL) steps.

The compute service manager 108, or other component of the cloud data platform 102, provides a developer framework to enable Python (or other programming languages) programming directly against platform data and services. Example embodiments include reading data into platform native dataframes and Pandas-compatible dataframes; leveraging Python data transformations, scripts, and libraries; writing data back to the platform; creating and invoking custom Python user-defined functions and stored procedures; and applying Python machine learning models for predictive analytics. This deeply integrated Python (other programming languages) programming experience allows developers, via client device(s) 114 and developer framework 140, to build complex analytical workflows that leverage both the flexibility of Python and the scale, concurrency, and performance of the cloud data platform 102. The developer framework 140 eliminates extract, transform, and load burdens, enables code re-use and portability, and brings advanced analytics like predictive modeling directly to data residing on the cloud data platform. By bridging Python (or other programming languages) and SQL programming styles, the developer framework 140 boosts developer productivity and advanced analytic capability for the cloud data platform.

The developer framework 140 can include a function invocation provided by a dataframe library, such as Pandas or Spark®, which implements operations on the dataframe for data tasks. dataframe libraries implement a functional abstraction layer enabling users to manipulate in-memory tabular data structures known as dataframes. This is provided via an expressive application programming interface (API) of functions and methods tailored for data preparation, transformation, analysis, and visualization tasks. dataframe A Pls allow accessing, filtering, aggregating, pivoting, joining and otherwise operating on dataframe data using concise and intuitive syntax. The API calls, such as dataframe API call 144, map to underlying queries, such as SQL query 138, and data processing engines (not shown) in the client environment 116 and/or the server environment 118. According to some examples of the developer framework 140, examples of client A Pls for invoking the dynamic pivot capability include, for example: developer framework Python API as df.pivot( ), developer framework Scala API as df.pivot( ), developer framework Java API as dataframe.pivot( ), cloud data platform SQL as PIVOT syntax, developer framework R API as pivot_table( ).

According to additional examples, during distributed execution, shuffle operations and data exchanges work as follows: the initial group by aggregations are computed locally on each worker's data partitions, this intermediate aggregated data is shuffled across nodes to compute the object aggregation, and the object aggregation output is partitioned again and shuffled to materialize the final pivot columns. Data partitioning schemes optimize shuffle sizes between stages to minimize data exchange and a resource manager, such as a cluster resource manager, handles routing of all intermediate shuffle data exchanges between worker nodes. Examples of shuffle operations exchange intermediate results between stages of distributed aggregation and materialization to efficiently compute the pivot across massive datasets.

In other examples, a JDBC or ODBC driver can exist on a server-side of the cloud data platform 102, such as server environment 118. For example, the server environment 118 can include a presentation server implementation code that provides server-side functionality via the network 106 to the client environment 116. In some embodiments, the user of the client device(s) 114 can be a data provider configured to provide services to other users, such as data consumers 115. While certain functions of the computing environment 100 are described herein as being performed by either a client environment 116 or by the server environment 118, the location of certain functionality either within the client environment 116 or the server environment 118 may be a design choice. For example, it may be technically preferable to initially deploy particular technology and functionality within the server environment 118 but to later migrate this technology and functionality to the client environment 116 where a user system, such as the client device(s) 114, has sufficient processing capacity.

In the description below, actions are ascribed to users of the cloud data platform. Such actions shall be understood to be performed concerning client device(s) 114 (or a singular client device) operated by such users. For example, a notification to a user may be understood to be a notification transmitted to the client device(s) 114, input or instruction from a user may be understood to be received by way of the client device(s) 114, and interaction with an interface by a user shall be understood to be interaction with the interface on the client device(s) 114. In addition, database operations (e.g., joining, aggregating, analysis, etc.) ascribed to a user of the cloud data platform shall be understood to include performing such actions by the cloud computing service 103 in response to an instruction from that user.

The compute service manager 108 is also coupled to one or more metadata databases 112 that store metadata about various functions and aspects associated with the cloud data platform 102 and its users. For example, the one or more metadata databases 112 may include a summary of data stored in remote data storage systems as well as data available from a local cache. Additionally, the one or more metadata databases 112 may include information regarding how data is organized in remote data storage systems (e.g., the storage platform 104) and the local caches. Information stored by the one or more metadata databases 112 allows systems and services to determine whether a piece of data needs to be accessed without loading or accessing the actual data from a storage device. In some embodiments, the one or more metadata databases 112 are configured to store account object metadata (e.g., account objects used in connection with a replication group object).

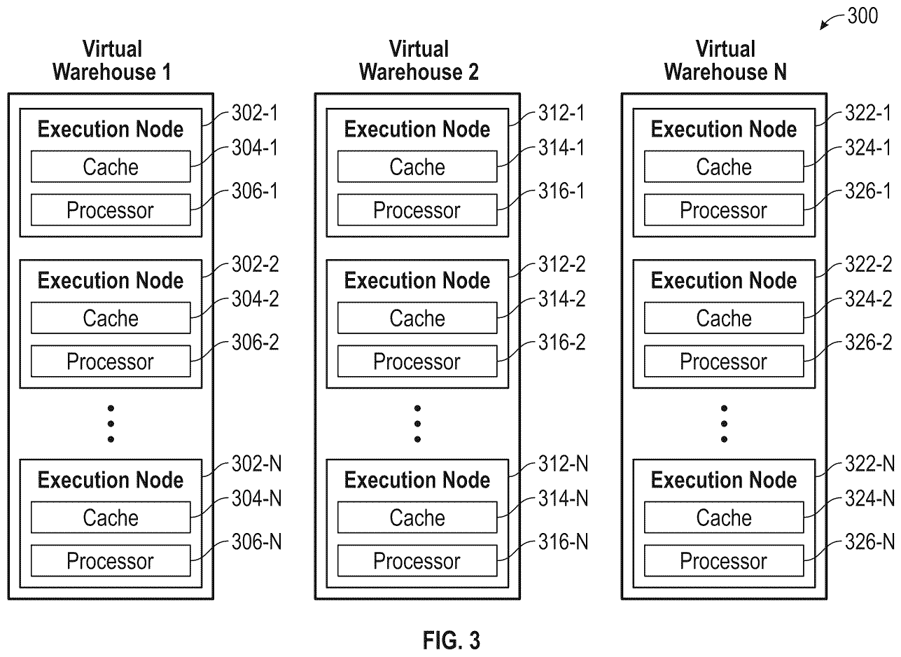

The compute service manager 108 is further coupled to the execution platform 110, which provides multiple computing resources that execute various data storage and data retrieval tasks. As illustrated in FIG. 3, the execution platform 110 comprises a plurality of compute nodes. The execution platform 110 is coupled to storage platform 104 and cloud-storage platforms 122a, 122b . . . , 122c (collectively referred to as storage platforms 122). The storage platform 104 comprises multiple data storage devices 120-1 to 120-N. In some embodiments, the data storage devices 120-1 to 120-N are cloud-based storage devices located in one or more geographic locations. For example, the data storage devices 120-1 to 120-N may be part of a public cloud infrastructure or a private cloud infrastructure. The data storage devices 120-1 to 120-N may be hard disk drives (HDDs), solid-state drives (SSDs), storage clusters, Amazon S3™ storage systems, or any other data-storage technology. Additionally, the storage platform 104 may include distributed file systems (such as Hadoop Distributed File Systems (HDFS)), object storage systems, and the like. In some embodiments, at least one internal stage 126 may reside on one or more of the data storage devices 120-1-120-N, and an external stage 124 may reside on one or more of the storage platforms 122.

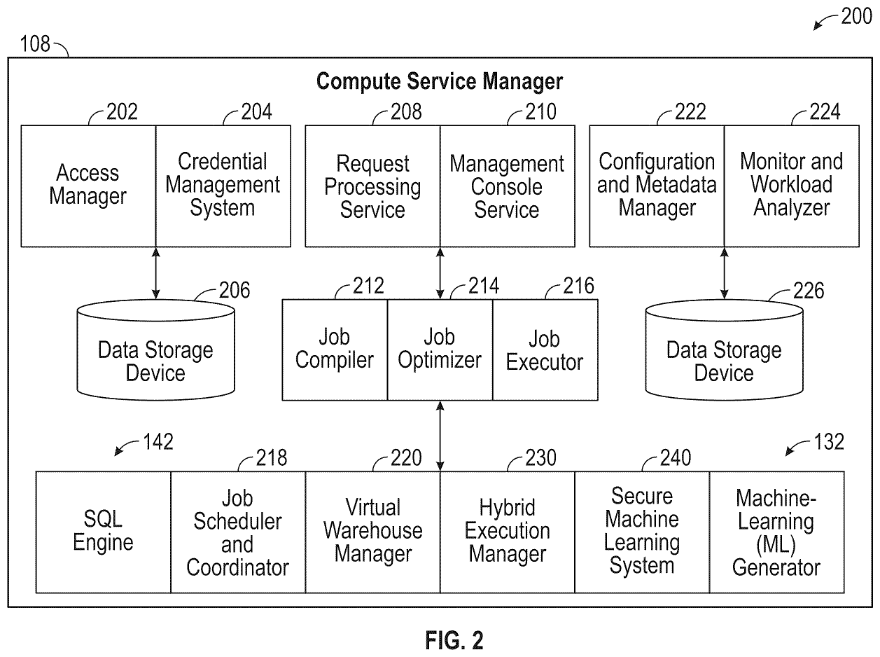

In some embodiments, the cloud data platform 102 includes a machine-learning (ML) generator 132. The ML generator 132 comprises suitable circuitry, interfaces, logic, and/or code and is configured to provide generation of ML models for extracting information from one or more documents (e.g., electronic documents) according to various embodiments. In some embodiments, the ML generator 132 can include one or more system functions that can be used to implement a method of generating an ML model as described herein. In some examples, the ML generator 132 can be operatively interconnected to the compute service manager 108, within the compute service manager 108 (as depicted in FIG. 2), connected to the execution platform 110, connected to the meta database(s) 112, or otherwise connected within or operatively to the cloud data platform 102 via additional external connections.

The execution platform 110 comprises a plurality of compute nodes. A set of processes on a compute node executes a query plan compiled by the compute service manager 108. Examples of the query plan can be generated and consumed in execution platform 110 by an RSO, table scan, or another scanner layer. The query plan can be built from an execution plan to extract from files, such as micro-partition files (e.g., horizontal (grouped by rows) partition of data within a database) and the columns consumed, and as needed, materialize (e.g., build) columns that are sharded in sub-columns, and convert the data when it needs to be cast to a different but compatible data types. The set of processes can include: a first process to execute the query plan; a second process to monitor and delete cache files using a least recently used (LRU) policy and implement an out of memory (OOM) error mitigation process; a third process that extracts health information from process logs and status to send back to the compute service manager 108; a fourth process to establish communication with the compute service manager 108 after a system boot; and a fifth process to handle all communication with a compute cluster for a given job provided by the compute service manager 108 and to communicate information back to the compute service manager 108 and other compute nodes of the execution platform 110.

In some embodiments, communication links between elements of the computing environment 100 are implemented via one or more data communication networks. These data communication networks may utilize any communication protocol and any type of communication medium. In some embodiments, the data communication networks are a combination of two or more data communication networks (or sub-networks) coupled to one another. In alternate embodiments, these communication links are implemented using any type of communication medium and any communication protocol.

The compute service manager 108, the one or more metadata databases 112, the execution platform 110, and the storage platform 104, are shown in FIG. 1 as individual discrete components. However, each of the compute service manager 108, the one or more metadata databases 112, execution platform 110, and storage platform 104 may be implemented as a distributed system (e.g., distributed across multiple systems/platforms at multiple geographic locations). Additionally, each of the compute service manager 108, the one or more metadata databases 112, execution platform 110, and storage platform 104 can be scaled up or down (independently of one another) depending on changes to the requests received and the changing needs of the cloud data platform 102. Thus, in the described embodiments, the cloud data platform 102 is dynamic and supports regular changes to meet the current data processing needs.

During a typical operation, the cloud data platform 102 processes multiple jobs determined by the compute service manager 108. These jobs are scheduled and managed by the compute service manager 108 to determine when and how to execute the job. For example, the compute service manager 108 may divide the job into multiple discrete tasks and may determine what data is needed to execute each of the multiple discrete tasks. The compute service manager 108 may assign each of the multiple discrete tasks to one or more nodes of the execution platform 110 to process the task. The compute service manager 108 may determine what data is needed to process a task and further determine which nodes within the execution platform 110 are best suited to process the task. Some nodes may have already cached the data needed to process the task and, therefore, be good candidates for processing the task. Metadata stored in the one or more metadata databases 112 assists the compute service manager 108 in determining which nodes in the execution platform 110 have already cached at least a portion of the data needed to process the task. One or more nodes in the execution platform 110 process the task using data cached by the nodes and, if necessary, data retrieved from the storage platform 104. It is desirable to retrieve as much data as possible from caches within the execution platform 110 because the retrieval speed is typically much faster than retrieving data from the storage platform 104.

Data platforms are widely used for data storage and data access in computing and communication contexts. Concerning architecture, a data platform could be an on-premises data platform, a network-based data platform (e.g., a cloud-based data platform), a combination of the two, and/or include another type of architecture. Concerning the type of data processing, a data platform could implement online analytical processing (OLAP), online transactional processing (OLTP), a combination of the two, and/or another type of data processing. Moreover, a data platform could be or include a relational database management system (RDBMS) and/or one or more other types of database management systems.

In a typical implementation, a cloud data platform 102 can include one or more databases that are respectively maintained in association with any number of customer accounts (e.g., accounts of one or more data providers), as well as one or more databases associated with a system account (e.g., an administrative account) of the data platform, one or more other databases used for administrative purposes, and/or one or more other databases that are maintained in association with one or more other organizations and/or for any other purposes. A cloud data platform 102 may also store metadata (e.g., account object metadata) in association with the data platform in general and in association with, for example, particular databases and/or particular customer accounts as well. Users and/or executing processes that are associated with a given customer account may, via one or more types of clients, be able to cause data to be ingested into the database, and may also be able to manipulate the data, add additional data, remove data, run queries against the data, generate views of the data, and so forth. As used herein, the terms “account object metadata” and “account object” are used interchangeably.

In an implementation of a cloud data platform 102, a given database (e.g., a database maintained for a customer account) may reside as an object within, e.g., a customer account, which may also include one or more other objects (e.g., users, roles, grants, shares, warehouses, resource monitors, integrations, network policies, and/or the like). Furthermore, a given object such as a database may itself contain one or more objects such as schemas, tables, materialized views, and/or the like. A given table may be organized as a collection of records (e.g., rows) so that each includes a plurality of attributes (e.g., columns). In some implementations, database data is physically stored across multiple storage units, which may be referred to as files, blocks, partitions, micro-partitions, and/or by one or more other names. In many cases, a database on a data platform serves as a backend for one or more applications that are executing on one or more application servers.

A database can include a repository of data for a customer of the cloud data platform, where the data is stored in tables that can be managed and queried. A database of the cloud data platform holds a collection of schemas, and a schema holds a collection of objects that can be tables and views. For example, a table stores data and can be queried. A view is a logical grouping (e.g., a SQL query) to create a virtual table that can be queried as if it was a real (e.g., non-virtual) table. A view may include, for example, a materialized view, which is a special view that provides a faster way to access tables. The materialized view is backed by physical (e.g., hidden) tables that can use different key orderings.

As shown in FIG. 1, the cloud computing platform 101 of the computing environment 100 separates the execution platform 110 from the storage platform 104. In this arrangement, the processing resources and cache resources in the execution platform 110 operate independently of the data storage devices 120-1 to 120-N in the storage platform 104. Thus, the computing resources and cache resources are not restricted to specific data storage devices 120-1 to 120-N. Instead, all computing resources and all cache resources may retrieve data from, and store data to, any of the data storage resources in the storage platform 104.

FIG. 2 is a block diagram 200 illustrating components of the compute service manager 108, in accordance with some embodiments of the present disclosure. As shown in FIG. 2, the compute service manager 108 includes an access manager 202 and a credential management system 204 coupled to data storage device 206, which is an example of the metadata databases 112. Access manager 202 handles authentication and authorization tasks for the systems described herein.

The credential management system 204 facilitates use of remote stored credentials to access external resources such as data resources in a remote storage device. As used herein, the remote storage devices may also be referred to as “persistent storage devices” or “shared storage devices.” For example, the credential management system 204 may create and maintain remote credential store definitions and credential objects (e.g., in the data storage device 206). A remote credential store definition identifies a remote credential store and includes access information to access security credentials from the remote credential store. A credential object identifies one or more security credentials using non-sensitive information (e.g., text strings) that are to be retrieved from a remote credential store for use in accessing an external resource. When a request invoking an external resource is received at run time, the credential management system 204 and access manager 202 use information stored in the data storage device 206 (e.g., access metadata database, a credential object, and a credential store definition) to retrieve security credentials used to access the external resource from a remote credential store.

A request processing service 208 manages received data storage requests and data retrieval requests (e.g., jobs to be performed on database data). For example, the request processing service 208 may determine the data to process a received query (e.g., a data storage request or data retrieval request). The data may be stored in a cache within the execution platform 110 or in a data storage device in cloud storage platform 104.

A management console service 210 supports access to various systems and processes by administrators and other system managers. Additionally, the management console service 210 may receive a request to execute a job and monitor the workload on the system.

The compute service manager 108 also includes a job compiler 212, a job optimizer 214, and a job executor 216. The job compiler 212 parses a job into multiple discrete tasks and generates the execution code for each of the multiple discrete tasks. The job optimizer 214 determines the best method to execute the multiple discrete tasks based on the data that needs to be processed. The job optimizer 214 also handles various data pruning operations and other data optimization techniques to improve the speed and efficiency of executing the job. The job executor 216 executes the execution code for jobs received from a queue or determined by the compute service manager 108.

A job scheduler and coordinator 218 sends received jobs to the appropriate services or systems for compilation, optimization, and dispatch to the execution platform 110 of FIG. 1. For example, jobs may be prioritized and then processed in the prioritized order. In an embodiment, the job scheduler and coordinator 218 determines a priority for internal jobs that are scheduled by the compute service manager 108 of FIG. 1 with other “outside” jobs such as user queries that may be scheduled by other systems in the database but may utilize the same processing resources in the execution platform 110. In some embodiments, the job scheduler and coordinator 218 identifies or assigns particular nodes in the execution platform 110 to process particular tasks. A virtual warehouse manager 220 manages the operation of multiple virtual warehouses implemented in the execution platform 110. For example, the virtual warehouse manager 220 may generate query plans for executing received queries, requests, or the like.

As illustrated, the compute service manager 108 includes a configuration and metadata manager 222, which manages the information related to the data stored in the remote data storage devices and in the local buffers (e.g., the buffers in execution platform 110). The configuration and metadata manager 222 uses metadata to determine which data files need to be accessed to retrieve data for processing a particular task or job. A monitor and workload analyzer 224 oversees processes performed by the compute service manager 108 and manages the distribution of tasks (e.g., workload) across the virtual warehouses and execution nodes in the execution platform 110. The monitor and workload analyzer 224 also redistributes tasks, as needed, based on changing workloads throughout the cloud data platform 102 and may further redistribute tasks based on a user (e.g., “external”) query workload that may also be processed by the execution platform 110. The configuration and metadata manager 222 and the monitor and workload analyzer 224 are coupled to a data storage device 226. Data storage device 226 represents any data storage device within the cloud data platform 102. For example, data storage device 226 may represent buffers in execution platform 110, storage devices in cloud storage platform 104, or any other storage device.

As described in embodiments herein, the compute service manager 108 validates all communication from an execution platform (e.g., the execution platform 110) to validate that the content and context of that communication are consistent with the task(s) known to be assigned to the execution platform. For example, an instance of the execution platform executing a query A should not be allowed to request access to data-source D (e.g., data storage device 226) that is not relevant to query A. Similarly, a given execution node (e.g., execution node 302-1 of FIG. 3) may need to communicate with another execution node (e.g., execution node 302-2 of FIG. 3), but should be disallowed from communicating with a third execution node (e.g., execution node 312-1), and any such illicit communication can be recorded (e.g., in a log or other location). Also, the information stored on a given execution node is restricted to data relevant to the current query, and any other data is unusable, rendered so by destruction or encryption where the key is unavailable.

A hybrid execution manager 230 facilitates hybrid execution of a dataframe input request, as described in further detail below. The hybrid execution manager 230 may assist with transferring dataframes to and from the cloud data platform 102 based on engine switching, as described in further detail below.

The compute service manager 108 can include a SQL engine 142 and/or be operatively connected to the SQL engine 142 configured to generate dynamic pivot functionality via a database system backend, such as the server environment 118 or the SQL engine 142, transforms data into optimized queries using object aggregation, deterministic ordering, or the like to efficiently compute results of the SQL query 138 including the dynamic pivot, in accordance with example embodiments of the present disclosure.

As previously mentioned, the compute service manager 108 can include the ML generator 132 and/or be operatively interconnected to the ML generator 132 configured to generate ML model for extracting information from one or more documents according to various embodiments. As explained throughout, in some example embodiments, the ML generator 132 can be integrated into hybrid execution framework, and/or used in conjunction with, parallel to, or in combination with a secure machine learning system 240 as depicted and described above with reference to FIG. 2. The database clean room enables two or more end-users of the cloud data platform 102 to share and collaborate on their sensitive data, without directly revealing that data to other participants. In alternative example embodiments, the ML generator 132 can be configured externally from compute service manager 108 and from cloud data platform 102, instead being operatively interconnected via one or more layers.

FIG. 3 is a block diagram 300 illustrating components of the execution platform 110 of FIG. 1, in accordance with some embodiments of the present disclosure. As shown in FIG. 3, the execution platform 110 includes multiple virtual warehouses, including virtual warehouse 1, virtual warehouse 2, and virtual warehouse N. Each virtual warehouse includes multiple execution nodes that each include a data cache and a processor. The virtual warehouses can execute multiple tasks in parallel by using the multiple execution nodes. As discussed herein, the execution platform 110 can add new virtual warehouses and drop existing virtual warehouses in real-time based on the current processing needs of the systems and users. This flexibility allows the execution platform 110 to quickly deploy large amounts of computing resources when needed without being forced to continue paying for those computing resources when they are no longer needed. All virtual warehouses can access data from any data storage device (e.g., any storage device in cloud storage platform 104).

Although each virtual warehouse shown in FIG. 3 includes three execution nodes, a particular virtual warehouse may include any number of execution nodes. Further, the number of execution nodes in a virtual warehouse is dynamic, such that new execution nodes are created when additional demand is present, and existing execution nodes are deleted when they are no longer useful.

Each virtual warehouse is capable of accessing any of the data storage devices 120-1 to 120-N shown in FIG. 1. Thus, the virtual warehouses are not necessarily assigned to a specific data storage device 120-1 to 120-N and, instead, can access data from any of the data storage devices 120-1 to 120-N within the cloud storage platform 104. Similarly, each of the execution nodes shown in FIG. 3 can access data from any of the data storage devices 120-1 to 120-N. In some embodiments, a particular virtual warehouse or a particular execution node may be temporarily assigned to a specific data storage device, but the virtual warehouse or execution node may later access data from any other data storage device.

In the example of FIG. 3, virtual warehouse 1 includes three execution nodes 302-1, 302-2, and 302-N. Execution node 302-1 includes a cache 304-1 and a processor 306-1. Execution node 302-2 includes a cache 304-2 and a processor 306-2. Execution node 302-N includes a cache 304-N and a processor 306-N. Each execution node 302-1, 302-2, and 302-N is associated with processing one or more data storage and/or data retrieval tasks. For example, a virtual warehouse may handle data storage and data retrieval tasks associated with an internal service, such as a clustering service, a materialized view refresh service, a file compaction service, a storage procedure service, or a file upgrade service. In other implementations, a particular virtual warehouse may handle data storage and data retrieval tasks associated with a particular data storage system or a particular category of data.

Similar to virtual warehouse 1 discussed above, virtual warehouse 2 includes three execution nodes 312-1, 312-2, and 312-N. Execution node 312-1 includes a cache 314-1 and a processor 316-1. Execution node 312-2 includes a cache 314-2 and a processor 316-2. Execution node 312-N includes a cache 314-N and a processor 316-N. Additionally, virtual warehouse 3 includes three execution nodes 322-1, 322-2, and 322-N. Execution node 322-1 includes a cache 324-1 and a processor 326-1. Execution node 322-2 includes a cache 324-2 and a processor 326-2. Execution node 322-N includes a cache 324-N and a processor 326-N.

In some embodiments, the execution nodes shown in FIG. 3 are stateless with respect to the data being cached by the execution nodes. For example, these execution nodes do not store or otherwise maintain state information about the execution node, or the data being cached by a particular execution node. Thus, in the event of an execution node failure, the failed node can be transparently replaced by another node. Since there is no state information associated with the failed execution node, the new (replacement) execution node can easily replace the failed node without concern for recreating a particular state.

Although the execution nodes shown in FIG. 3 each include one data cache and one processor, alternate embodiments may include execution nodes containing any number of processors and any number of caches. Additionally, the caches may vary in size among the different execution nodes. The caches shown in FIG. 3 store, in the local execution node, data that was retrieved from one or more data storage devices in cloud storage platform 104 of FIG. 1. Thus, the caches reduce or eliminate the bottleneck problems occurring in platforms that consistently retrieve data from remote storage systems. Instead of repeatedly accessing data from the remote storage devices, the systems and methods described herein access data from the caches in the execution nodes, which is significantly faster and avoids the bottleneck problem discussed above. In some embodiments, the caches are implemented using high-speed memory devices that provide fast access to the cached data. Each cache can store data from any of the storage devices in the cloud storage platform 104.

Further, the cache resources and computing resources may vary between different execution nodes. For example, one execution node may contain significant computing resources and minimal cache resources, making the execution node useful for tasks that require significant computing resources. Another execution node may contain significant cache resources and minimal computing resources, making this execution node useful for tasks that require caching of large amounts of data. Yet, another execution node may contain cache resources providing faster input-output operations, useful for tasks that require fast scanning of large amounts of data. In some embodiments, the cache resources and computing resources associated with a particular execution node are determined when the execution node is created, based on the expected tasks to be performed by the execution node.

Additionally, the cache resources and computing resources associated with a particular execution node may change over time based on changing tasks performed by the execution node. For example, an execution node may be assigned more processing resources if the tasks performed by the execution node become more processor intensive. Similarly, an execution node may be assigned more cache resources if the tasks performed by the execution node require a larger cache capacity.

Although virtual warehouses 1, 2, and N are associated with the same execution platform 110, the virtual warehouses may be implemented using multiple computing systems at multiple geographic locations. For example, virtual warehouse 1 can be implemented by a computing system at a first geographic location, while virtual warehouses 2 and N are implemented by another computing system at a second geographic location. In some embodiments, these different computing systems are cloud-based computing systems maintained by one or more different entities.

Additionally, each virtual warehouse is shown in FIG. 3 as having multiple execution nodes. The multiple execution nodes associated with each virtual warehouse may be implemented using multiple computing systems at multiple geographic locations. For example, an instance of virtual warehouse 1 implements execution nodes 302-1 and 302-2 on one computing platform at a geographic location and implements execution node 302-N at a different computing platform at another geographic location. Selecting particular computing systems to implement an execution node may depend on various factors, such as the level of resources needed for a particular execution node (e.g., processing resource requirements and cache requirements), the resources available at particular computing systems, communication capabilities of networks within a geographic location or between geographic locations, and which computing systems are already implementing other execution nodes in the virtual warehouse.

Execution platform 110 is also fault tolerant. For example, if one virtual warehouse fails, that virtual warehouse is quickly replaced with a different virtual warehouse at a different geographic location. A particular execution platform 110 may include any number of virtual warehouses. Additionally, the number of virtual warehouses in a particular execution platform is dynamic, such that new virtual warehouses are created when additional processing and/or caching resources are needed. Similarly, existing virtual warehouses may be deleted when the resources associated with the virtual warehouse are no longer useful.

In some embodiments, the virtual warehouses may operate on the same data in cloud storage platform 104, but each virtual warehouse has its own execution nodes with independent processing and caching resources. This configuration allows requests on different virtual warehouses to be processed independently and with no interference between the requests. This independent processing, combined with the ability to dynamically add and remove virtual warehouses, supports the addition of new processing capacity for new users without impacting the performance.

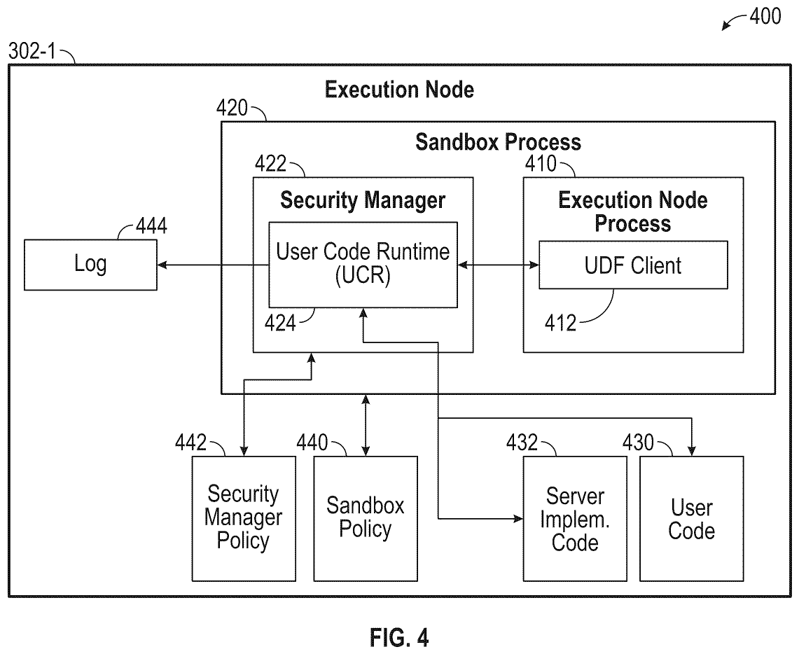

FIG. 4 is a computing environment 400 conceptually illustrating an example software architecture executing a user-defined function (UDF) by a process running on a given execution node of the execution platform 110 of FIG. 3, in accordance with some embodiments of the present disclosure.

As illustrated, the execution node 302-1 from the execution platform 110 includes an execution node process 410, which in an embodiment is running on the processor 306-1 and can also utilize memory from the cache 304-1 (or another memory device or storage). As mentioned herein, a “process” or “computing process” can refer to an instance of a computer program that is being executed by one or more threads by an execution node or execution platform.

As mentioned before, the compute service manager 108 of FIG. 1 validates all communication from the execution platform 110 of FIG. 1 to validate that the content and context of that communication are consistent with the task(s) known to be assigned to the execution platform 110. For example, the execution platform 110 executing a query A is not allowed to request access to a particular data source (e.g., data storage device 226 of FIG. 2 or any one of the storage devices in the cloud storage platform 104) that is not relevant to query A. In an example, the execution node 302-1 may need to communicate with a second execution node (e.g., execution node 302-2), but the security mechanisms described herein can disallow communication with a third execution node (e.g., execution node 312-1). Moreover, any such illicit communication can be recorded (e.g., in a log 444 or other location). Further, the information stored on a given execution node is restricted to data relevant to the current query and any other data is unusable by destruction or encryption where the key is unavailable.

The execution node process 410 is executing a UDF client 412 in the example of FIG. 4. In an embodiment, the UDF client 412 is implemented to support UDFs written in a particular programming language such as JAVA, and the like. In an embodiment, the UDF client 412 is implemented in a different programming language (e.g., C or C++) than the user code 430, which can further improve security of the computing environment 400 by using a different codebase (e.g., one with the same or fewer potential security exploits).

User code 430 may be provided as a package, e.g., in the form of a JAR (JAVA archive) file, which includes code for one or more UDFs (e.g., extension functions). Server implementation code 432, in an embodiment, is a JAR file that initiates a server which is responsible for receiving requests from the execution node process 410, assigning worker threads to execute user code, and returning the results, among other types of server tasks.

In an implementation, an operation from a UDF (e.g., JAVA-based UDF) can be performed by a user code runtime 424 executing within a sandbox process 420. In an embodiment, the user code runtime 424 is implemented as a virtual machine, such as a JAVA virtual machine (JVM). Since the user code runtime 424 executes in a separate process relative to the execution node process 410, there is a lower risk of manipulating the execution node process 410. Results of performing the operation, among other types of information or messages, can be stored in a log 444 for review and retrieval. In an embodiment, the log 444 can be stored locally in memory at the execution node 302-1, or at a separate location such as the cloud storage platform 104.

Examples of the log 444 can include logging for observability and debuggability. Logging can be automatically configured to observe egress traffic using a logging mechanism with runtime-configurable verbosity levels. For example, use of an event output log or event output helper can allow for passing custom structs from the eBPF program to a performance event ring buffer along with an optional packet sample. In response, the execution platform worker can pull the logs from log 444 or other logs from the buffer and write to execution platform logs, as an example. This channel can be used to log, debug, sample, and/or push notifications for network policy violations and the like. For example, the event output log or helper can be configured to pass the data through a lockless memory mapped per-CPU performance ring buffer, which is significantly faster (e.g., more efficient) than default logging support in eBPF.

Additional examples of the log 444 or other logs of the cloud data platform 102 can be used to provide clear and actionable feedback necessary for users if their UDF's packet has been blocked. With the logging mechanism, the cloud data platform 102 or a component thereof can report details back to the user (e.g., which IP and port has been blocked or violated the account policy). Additionally, when an unauthorized DNS request has been blocked, the eBPF program can intercept the packet and report back which hostname it tried to access and enter such information into the log 444, which is valuable for helping customers to troubleshoot and debug their UDF.

Moreover, such results can be returned from the user code runtime 424 to the UDF client 412 utilizing a high-performance protocol (e.g., without serialization or deserialization of data, without memory copies; operates on record batches without having to access individual columns, records, or cells; utilizes efficient remote procedure call techniques and network protocol(s) for data transfer) for data transfer (e.g., distributed datasets) that further provides authentication and encryption of the data transfer. In an embodiment, the UDF client 412 uses a data transport mechanism that supports a network transfer of columnar data between the user code runtime 424 (and vice-versa).

Security manager 422, in an example, can prevent completion of an operation from a given UDF by throwing an exception (e.g., if the operation is not permitted), or returns (e.g., doing nothing) if the operation is permitted. In an implementation, the security manager 422 is implemented as a JAVA security manager object that allows applications to implement a security policy such as a security manager policy 442, and enables an application to determine, before performing a possibly unsafe or sensitive operation, what the operation is and whether it is being attempted in a security context that allows the operation to be performed. The security manager policy 442 can be implemented as a file with permissions that the user code runtime 424 is granted. The application (e.g., UDF executed by the user code runtime 424) therefore can allow or disallow the operation based at least in part on the security policy.

Sandbox process 420, in an embodiment, is a sub-process (or separate process) from the execution node process 410. A sub-process, in an embodiment, refers to a child process of a given parent process (e.g., in this example, the execution node process 410). The sandbox process 420, in an example, is a program that reduces the risk of security breaches by restricting the running environment of untrusted applications using security mechanisms such as namespaces and secure computing modes (e.g., using a system call filter to an executing process and all its descendants, thus reducing the attack surface of the kernel of a given operating system). Moreover, in an example, the sandbox process 420 is a lightweight process in comparison to the execution node process 410 and is optimized (e.g., closely coupled to security mechanisms of a given operating system kernel) to process a database query in a secure manner within the sandbox environment.

For example, the instance of a computer program can be instantiated by the execution platform 110. For example, the execution node 302-1 can be configured for instantiating a user code runtime to execute the code of the UDF and/or to create a runtime environment that allows the user's code to be executed. The user code runtime can include an access control process including an access control list, where the access control list includes authorized hosts and access usage rights or other types of allow lists and/or block lists with access control information. Instantiating a sandbox process can determine whether the UDF is permitted and instantiating the user code runtime as a child process of the sandbox process, the sandbox process configured to execute the at least one operation in a sandbox environment.

In an embodiment, the sandbox process 420 can utilize a virtual network connection in order to communicate with other components within the subject system. A specific set of rules can be configured for the virtual network connection with respect to other components of the subject system. For example, such rules for the virtual network connection can be configured for a particular UDF to restrict the locations (e.g., particular sites on the Internet or components that the UDF can communicate) that are accessible by operations performed by the UDF. Thus, in this example, the UDF can be denied access to particular network locations or sites on the Internet.

The sandbox process 420 can be understood as providing a constrained computing environment for a process (or processes) within the sandbox, where these constrained processes can be controlled and restricted to limit access to certain computing resources.

Examples of security mechanisms can include the implementation of namespaces in which each respective group of processes executing within the sandbox environment has access to respective computing resources (e.g., process IDs, hostnames, user IDs, file names, names associated with network access, inter-process communication, and the like) that are not accessible to another group of processes (which may have access to a different group of resources not accessible by the former group of processes), other container implementations, and the like. By having the sandbox process 420 execute as a sub-process to the execution node process 410, in some embodiments, latency in processing a given database query can be substantially reduced (e.g., a reduction in latency by a factor of 10× in some instances) in comparison with other techniques that may utilize a virtual machine solution by itself.

As further illustrated, the sandbox process 420 can utilize a sandbox policy 440 to enforce a given security policy. The sandbox policy 440 can be a file with information related to a configuration of the sandbox process 420 and details regarding restrictions, if any, and permissions for accessing and utilizing system resources. Example restrictions can include restrictions to network access, or file system access (e.g., remapping file system to place files in different locations that may not be accessible, other files can be mounted in different locations, and the like). The sandbox process 420 restricts the memory and processor (e.g., CPU) usage of the user code runtime 424, ensuring that other operations on the same execution node can execute without running out of resources.

As mentioned above, the sandbox process 420 is a sub-process (or separate process) from the execution node process 410, which in practice means that the sandbox process 420 resides in a separate memory space than the execution node process 410. In an occurrence of a security breach in connection with the sandbox process 420 (e.g., by errant or malicious code from a given UDF), if arbitrary memory is accessed by a malicious actor, the data or information stored by the execution node process is protected.

Although the above discussion of FIG. 4 describes components that are implemented using JAVA (e.g., an object-oriented programming language), it is appreciated that the other programming languages (e.g., interpreted programming languages) are supported by the computing environment 400. In an embodiment, PYTHON is supported for implementing and executing UDFs in the computing environment 400. In this example, the user code runtime 424 can be replaced with a PYTHON interpreter for executing operations from UDFs (e.g., written in PYTHON) within the sandbox process 420.

As mentioned above, some dataframe operations, or at least some components of the dataframe operations, may perform differently across different workload characteristics and backend engines. For example, local engines (e.g., Pandas) may perform faster on smaller interactive workloads than cloud platform engines. However, as data size grows, cloud platform engines (e.g., Pandas) may perform better on large scale data. Next, hybrid execution frameworks for dataframe operations are described. The hybrid execution framework provides a unified interface for the user where the choice of the backend (local engine and/or cloud platform engine) is automatically determined. The hybrid execution framework may determine the optimal engines to perform dataframe operations based on characteristics, such as dataset size, API used, etc. A rules engine may gather statistics and metadata related to current operations within the workflow. The rules engine may determine engine switching for hybrid execution. The rules engine may also gather information related to the cost of running operations on each engine backend. The decision to switch engines may be based, at least in part, on the cost function of switching engines.

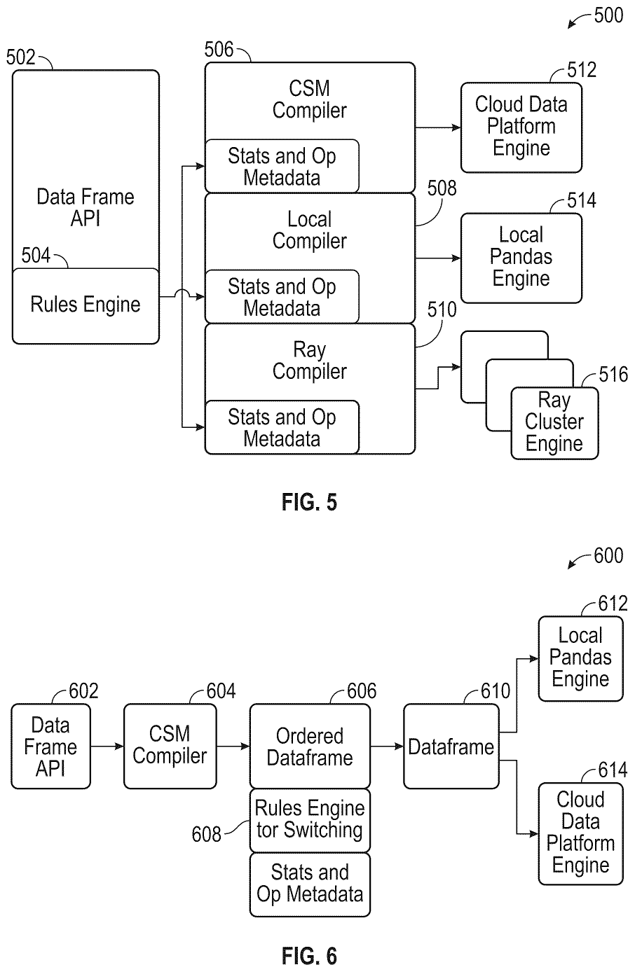

FIG. 5 is a block diagram of a hybrid execution framework 500, according to some example embodiments. A dataframe API 502 is configured to receive a system input. The system input may include a program, such as a PYTHON program. In some examples, the system input may include a workflow for data transformations, such as a pipeline. The workflow may include a set of operations.

The dataframe API 502 may manage execution of dataframe operations across different engines. The dataframe API 502 provides a unified interface for dataframe operations, allowing seamless integration with various backend engines. The dataframe API 502 enables users to automatically perform dataframe operations on different engine backends. The dataframe API 502 interacts with a rules engine 504 to gather statistics and metadata related to current operations within the dataframe workflow, facilitating automatic engine switching to optimize performance. In some examples, the dataframe API 502 may include a Modin interface, which is a drop-in replacement for Pandas enabling distribution of dataframe processing.

The rules engine 504 may include a set of rules to determine which engine is best suited to process certain parts or sections of the input, such as the program or workflow. The rules engine may gather statistics and metadata related to size of the dataset, dataset types, operation, and data types in the input, etc. The rules engine may also gather cost information relating to the cost of switching engines. The rules engine may determine a decision on which engine should execute certain parts or sections of the input based on the collected information.

The dataframe API 502 is coupled to a compute service manager (CSM) compiler 506, a local compiler 508, and another engine compiler 510 (e.g., Ray compiler 510 in this example). Based on the decision of which engine is best suited to handle certain parts or sections of the input, the dataframe API 502 may then route the respective parts or sections of the input to a chosen engine compiler.

The CSM engine compiler 506 is coupled to a cloud data platform engine 512 for dataframe operations, as described above with reference to FIGS. 1-4. The cloud data platform engine 512 may execute dataframe operations in a remote cloud computing environment, as described above. The CSM engine compiler 506 with the cloud data platform engine 512 is designed for executing dataframe operations within the cloud data platform. The CSM engine compiler 506 compiles operations to be executed on the cloud data platform engine 512, leveraging the data processing capabilities and scalability of the cloud data platform engine 512. The CSM engine compiler 506 gathers statistics and metadata about the operations being processed, which are used by the rules engine 504 to optimize execution strategies. The CSM engine compiler 506 with the cloud data platform engine 512 is well-suited for handling large-scale data processing tasks that benefit from the cloud platform's columnar storage and distributed query execution engine.

The local engine compiler 508 is coupled to local Pandas engine 514. The local Pandas engine 514 is provided locally on the client machine. In some examples, the local Pandas engine 514 may be a single-threaded engine as compared to the multiple-threaded engine of the cloud data platform engine 512. The local engine compiler 508 is designed to handle dataframe operations that are more effectively executed in a local environment, typically for smaller datasets or operations that require low latency. The local engine compiler 508 compiles operations to be executed on the local Pandas engine 514, providing a fast and responsive execution environment for interactive data analysis tasks. The local engine compiler 508 collects statistics and metadata about the operations being processed, which are used by the rules engine 504 to decide whether to switch execution to a different engine.

The Ray engine compiler 510 is coupled to the Ray cluster engine 516. The other engine is shown here as a Ray engine for illustration purposes, and other types of number of engines may be incorporated into the framework. The Ray cluster engine 516 is a distributed computing environment that supports the execution of dataframe operations compiled by the Ray engine compiler 510. The Ray cluster engine 516 includes multiple nodes that work together to perform parallel processing of tasks, providing high scalability and fault tolerance. The Ray engine compiler 510 collects statistics and metadata about the operations being processed, which are used by the rules engine 504 to decide whether to switch execution to a different engine.

Different framework configurations may be used for hybrid execution. For example, the rules engine and the engine-selection logic may be provided in different components. FIG. 6 is a block diagram of a hybrid execution framework 600, according to some example embodiments. A dataframe API 602 receives a system input. The system input may include a program, such as a PYTHON program. In some examples, the system input may include a workflow for data transformations, such as a pipeline. The workflow may include a set of operations.

The dataframe API 602 may manage execution of dataframe operations across different engines. The dataframe API 602 provides a unified interface for dataframe operations, allowing seamless integration with various backend engines. The dataframe API 602 enables users to automatically perform dataframe operations on different engine backends. In some examples, the dataframe API 602 may include a Modin interface, which is a drop-in replacement for Pandas enabling distribution of dataframe processing.

The dataframe API 602 is coupled to a CSM compiler 604. The CSM compiler 604 may process the input received from the Data Frame API 602. The CSM compiler 604 may analyze the operations specified in the input and compile the operations into executable instructions.

The CSM compiler 604 generates a dataframe 606. A rules engine 608 may include a set of rules to determine which engine is best suited to process certain parts or sections of the input, such as the program or workflow. The rules engine may gather statistics and metadata related to size of the dataset, dataset types, operation types in the input, etc. The rules engine may also gather cost information relating to the cost of switching engines. The rules engine may make a decision on which engine should execute certain parts or sections of the input based on the collected information.

Respective dataframe 610 of the dataframe 606 may be routed to different backends, such as local Pandas engine 612, cloud data platform engine 614, and other types of backend engines (e.g., Ray cluster engine), based on the engine decision by the rules engine 608.

The local Pandas engine 612 is provided locally on the client machine. The local Pandas engine 612 may be a single-threaded engine as compared to the multiple-threaded engine of the cloud data platform engine 614. The local Pandas engine 612 is designed to handle dataframe operations that are more effectively executed in a local environment, typically for smaller datasets or operations that require low latency.

The cloud data platform engine 614 may execute dataframe operations in a remote cloud computing environment, as described above. The cloud data platform engine 614 is designed for executing dataframe operations within the cloud data platform. The cloud data platform engine 614 is well-suited for handling large-scale data processing tasks that benefit from the cloud platform's columnar storage and distributed query execution engine.

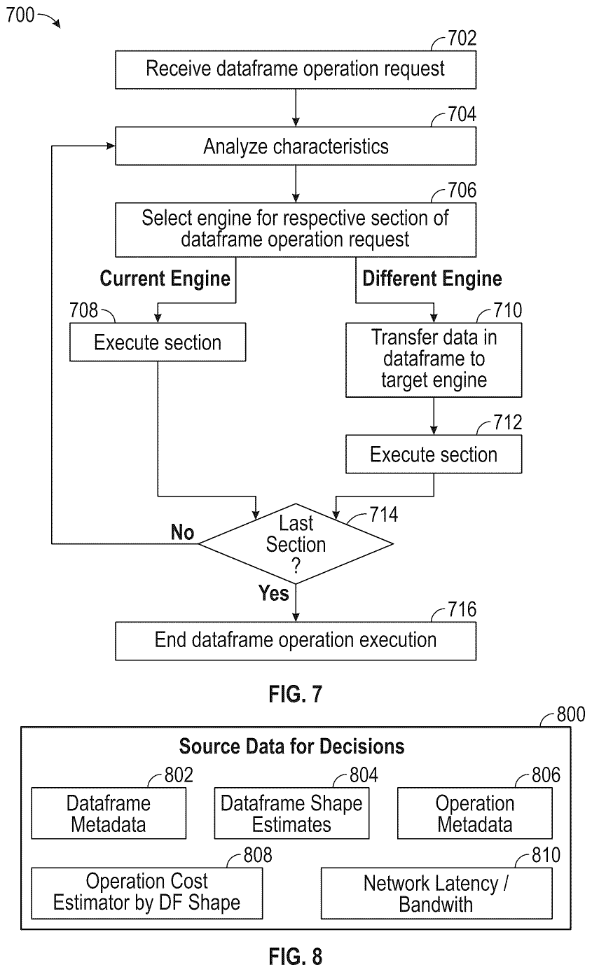

FIG. 7 shows a flowchart illustrating a method 700 for executing a dataframe operation across different engines, according to some example embodiments. For example, the method 700 can be embodied in machine-readable instructions or machine storage medium for execution by one or more hardware components such that the operations of the method 700 can be performed by components of the cloud data platform 102, the client environment 116, or other components operably interconnected thereto (see, e.g., FIGS. 5 and 6). It shall be appreciated that method 700 can be deployed on various other hardware configurations and is not intended to be limited to deployment within the cloud data platform 102. Depending on the embodiment, an operation (or step) of the method 700 can be repeated in different ways or involve intervening operations not shown. Though the operations of the method 700 can be depicted and described in a certain order, the order in which the operations are performed may vary among embodiments, including performing certain operations in parallel or performing sets of operations in separate processes. While the various operations in the method 700 are presented and described sequentially, one of ordinary skill will appreciate that some or all of the operations may be executed in a different order, be combined or omitted, or be executed in parallel.

At step 702, a dataframe operation request is received. The request specifies the operations to be performed on the dataframe, which may include transformations, aggregations, or other data manipulations. The request may include an order-dependent set of operations. The request may include a program, such as a PYTHON program. In some examples, the request may include a workflow for data transformations, such as a pipeline. The workflow may include a set of operations.

At step 704, the characteristics of the dataframe operation request is analyzed. This analysis may include evaluating factors such as the size and shape of the dataframe, the type of operations specified, the source origin of the dataframe, and the computational requirements of the operations. The analysis may include gathering of statistics and metadata related to size of the dataset, dataset types, operation types in the input, etc. The analysis is used for determining the optimal engine for executing each section of the request.

At step 706, the engine for executing a respective section of the dataframe operation request is selected. The selection is based on the analysis and considers factors such as the cost of execution, the capabilities of the available engines, and the workload characteristics. A rules engine, as described above, may perform the selection.

At step 708, if the selected engine corresponds to the engine currently in use, the respective section of the dataframe operation request is executed on the current engine in use. This execution involves processing the data in the current engine without transferring the data to another engine. For example, if the current engine is a cloud platform engine, then the cloud platform engine executes the respective section. And if the current engine is a local Pandas engine, then the local Pandas engine executes the respective section.

At step 710, if the selected engine is a different engine, the system transfers the dataframe data to the target engine. For example, if the current engine is a local Pandas engine and the selected engine for the next section is the cloud platform engine, then the dataframe is transferred to the cloud platform engine, where it may be stored in a temporary table. If the current engine is the cloud platform engine and the selected engine for the next section is the local Pandas engine, then the dataframe is transferred to the client device and stored in-memory for the local Pandas engine.

At step 712, the respective section of the dataframe operation request is executed on the selected engine using the transferred dataframe. The transfer to and execution by the selected engine may ensure that the respective section of the operation request is executed on the engine most appropriate for handling the workload, such as a distributed engine for large-scale data processing.

At step 714, the system checks whether the current section represents the final section of the dataframe operation request. If the current section does not represent the final section, the method loops back to step 704 to perform the analysis of the subsequent section.

If the current section represents the final section, the system, at step 716, ends the execution of the dataframe operation request. The results of the executed sections are returned to the user, ensuring that the operation is completed efficiently and accurately. In some examples, the user may be provided notification of the engine switching, such as notifications of when the dataframe is being transferred from one engine to another.

Engine selection may be performed using different selection optimization techniques. In some examples, a gross-level optimization may be used. In gross-level optimization, the engine selection decision may be performed at materialization and at other key decision points. This optimization technique may be behavior sensitive. The key decision points may include a specified set of operations, such as a creation of a dataframe (e.g., read command), replace, head, data egress, merge or concatenate with another dataframe. In this approach, the system runs the operation of the dataframe input request on the current engine until it reaches a specified decision point. At the decision point, the system determines if the next operation, which triggered the decision point, should be executed on the current engine or a different engine, as described above. The system continues the dataframe operations of the selected engine until the next specified decision point is reached and so on until the dataframe operations are completed.

In some examples, a holistic optimization may be used. Holistic optimization may use lazy evaluation where a sequence of operations is applied but not executed until materialization. Lazily evaluated dataframes can use holistic optimization at a materialization point to determine which operations should be performed by the lazy engine and which operations should be performed by another engine. Consider a set of expressions on a dataframe, e0 . . . m, where e′ is one evaluation engine and e″ is another evaluation engine. m represents a materialization point. et′n represents the time it takes to evaluate one of these expressions on the first engine, with et″n being the time it takes to evaluate the expression on the second. T(n) represents the transfer cost at point n. The system may pick n such that the following function is minimized:

$${\sum }_{i = 0}^{n} e {t}_{i}^{′} + T ( n ) + {\sum }_{i = n + 1}^{m} e {t}_{i}^{″}$$

This approach may include maintaining a history of each operation, en . . . em to determine the appropriate engine switching point.

In some examples, a greedy optimization may be used. The system can determine when to switch engines on an operation-by-operation basis, for example, when the following conditions apply:

$${\sum }_{i = 1}^{n} {et}_{i}^{′} > {T}_{n} + {et}_{n}^{″} - if the current engine is lazy$$

$${et}_{n}^{′} > {T}_{n} + {et}_{i}^{″} - if the current engine is eager$$

For greedy optimization, it may be assumed that the system can determine the cost of materialization on the current execution engine, as well as the transfer cost; however, it may also be assumed that the system can only estimate the cost of the next operation for each engine. This greedy optimization may not need a history of operations to consider as in the case of holistic optimization. This approach may introduce a level of uncertainty in the cost function if the current engine is lazy.

The engine selection decision may be based on different sources of data. FIG. 8 shows examples of Source Data 800 for decisions, according to some example embodiments. The Source Data 800 may include Dataframe Metadata 802, Dataframe Shape Estimates (DSE) 804, Operation Metadata 806, Operation Cost Estimator by dataframe Shape (OCEBDS) 808, and Network Latency/Bandwidth (NLB) 810.

The Dataframe Metadata 802 may include detailed information about the structure and attributes of dataframes. The Dataframe Metadata 802 may include metadata such as column names, data types, and indexing information.

The DSE 804 may provide predictions about the size and structure of dataframes after specific operations are performed. These estimates may be used in planning and improving subsequent operations, as they allow for adjustments based on anticipated changes in dataframe dimensions.

The Operation Metadata 806 may include information about the operations performed on dataframes, including their type, parameters, and execution context. The Operation Metadata 806 is used to track and analyze the performance and outcomes of operations, contributing to the overall efficiency of the system.

The OCEBDS 808 may evaluate the computational cost of performing operations on dataframes based on their shape. By analyzing the dimensions and structure of dataframes, the OCEBDS 808 provides estimates that help optimize resource allocation and execution strategies for various operations. The NLB 810 may include metrics related to the communication overhead associated with distributed operations on dataframe.

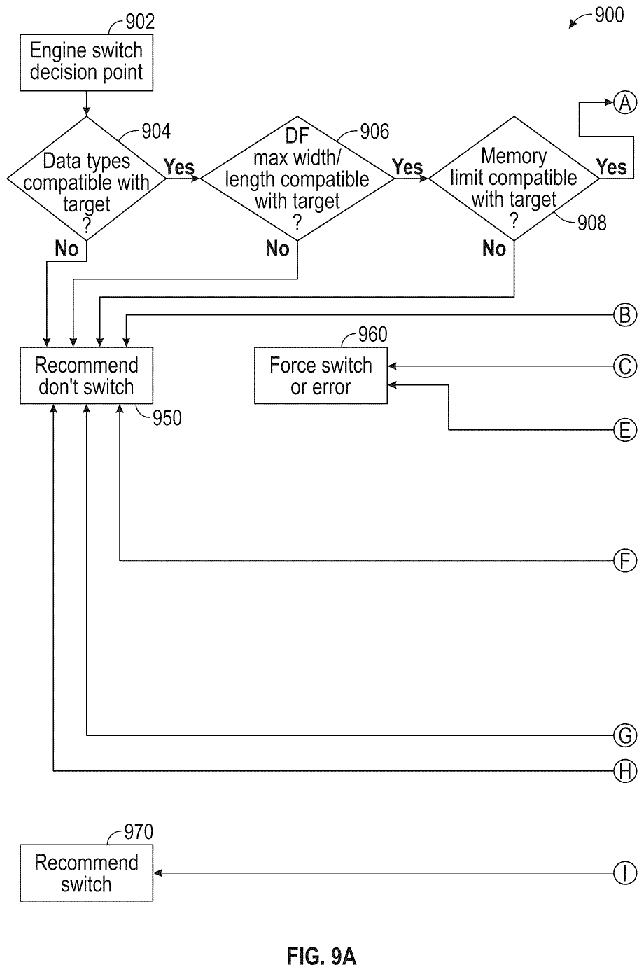

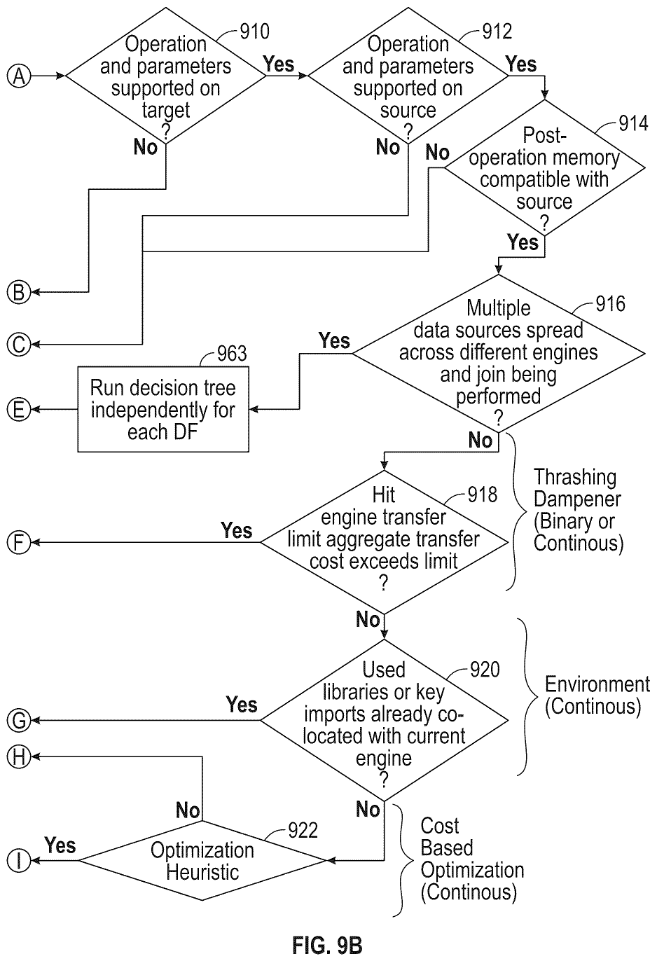

FIGS. 9A-9B show a flowchart illustrating a method 900 for a decision tree for switching execution engines for dataframe operations, according to some example embodiments. For example, the method 900 can be embodied in machine-readable instructions or machine storage medium for execution by one or more hardware components such that the operations of the method 900 can be performed by components of the cloud data platform 102, the client environment 116, or other components operably interconnected thereto (see, e.g., FIGS. 5 and 6). It shall be appreciated that method 900 can be deployed on various other hardware configurations and is not intended to be limited to deployment within the cloud data platform 102. Depending on the embodiment, an operation (or step) of the method 900 can be repeated in different ways or involve intervening operations not shown. Though the operations of the method 900 can be depicted and described in a certain order, the order in which the operations are performed may vary among embodiments, including performing certain operations in parallel or performing sets of operations in separate processes. While the various operations in the method 900 are presented and described sequentially, one of ordinary skill will appreciate that some or all of the operations may be executed in a different order, be combined or omitted, or be executed in parallel.

The method 900 may be triggered by an engine switch decision point and evaluates various factors, such as data type compatibility, DF max width/length compatibility, memory limit compatibility, operation and parameter compatibility, and post-operation memory compatibility. The method 900 may also consider other factors, such as use of multiple data sources, thrashing dampening, environment conditions, and cost-based optimization.

At step 902, an engine switch decision point is reached. The decision point may be based on which selection optimization technique is being employed, such as gross-level optimization, holistic optimization, and greedy optimization as described above. For example, in gross-level optimization, the decision point may correspond to one of a specified set of operations. In greedy optimization, the decision point may correspond to each operation.

At step 904, the system evaluates whether the data types of the dataframe are compatible with a target execution engine. If the data types are not compatible, the system recommends against switching engines (step 950). If the data types are compatible, the system continues to evaluate other factors.

At step 906, the system checks whether the maximum width and length of the dataframe are compatible with the target execution engine. If the dataframe dimensions are not compatible, the system recommends against switching engines (step 950). If the dimensions are compatible, the system continues to evaluate other factors.

At step 908, the system determines whether the memory limit of the target execution engine is compatible with the dataframe. If the memory limit is not compatible, the system recommends against switching engines (step 950). If the memory limit is compatible, the system continues to evaluate other factors.

At step 910, the system determines whether the operation and the associated parameters are supported on the target engine. If the operation and the associated parameters are not supported by the target engine, the system recommends against switching engines (step 950). If the operation and the associated parameters are supported by the target engine, the system continues to evaluate other factors.

At step 912, the system determines whether the operation and the associated parameters are supported on the source engine. If the operation and the associated parameters are not supported on the source engine, the system forces a switch to the target execution engine or generates an error if the system cannot proceed with the current engine (step 960). If the operation and the associated parameters are supported by the source engine, the system continues to evaluate other factors.

At step 914, the system determines whether the post-operation memory is compatible with the source engine. If the post-operation memory is not compatible, the system forces a switch to the target execution engine or generates an error if the system cannot proceed with the current engine (step 960). If the post-operation memory is compatible, the system continues to evaluate other factors.

At step 916, the system checks whether multiple data sources are spread across different engines and whether a join or similar operation is being performed. If this condition is met, the system may run the decision tree (i.e., method 900) independently for each dataframe and pick one engine for both dataframes (step 963). If picking one engine is not possible, then the system may force a switch or generate an error (step 960). If multiple data sources are not speared across different engines, the system continues to evaluate other factors.

At step 918, the system checks whether the aggregate transfer cost exceeds the engine transfer limit. If the transfer cost exceeds the limit, the method applies a thrashing dampener mechanism, which can be binary or continuous, to mitigate excessive resource usage. If the condition is met, the thrashing dampener recommends against switching engines (step 950). If the aggregate transfer cost does not exceed the limit, the system continues to evaluate other factors.

At step 920, the system determines whether libraries or key imports are already co-located with the current (source) engine. If the libraries or imports are co-located, the system recommends against switching engines (step 950). If they are not co-located, the system continues to evaluate other factors.

At step 922, the system evaluates cost-based optimization, which is referred to as optimization heuristic. This cost-based optimization may involve ongoing assessment of resource utilization and operational efficiency. Details of embodiments of the cost-based optimization are described herein in further detail. If the cost-based optimization does not yield a suitable result, the system recommends against switching engines (step 950). If the cost-based optimization yields a suitable result, the system recommends switching the engine to the target engine (step 970).

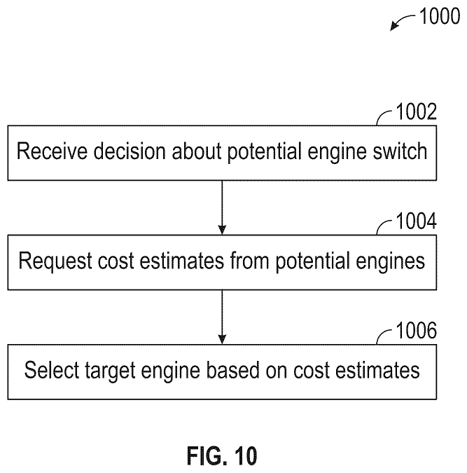

Costing optimization may be performed in a decentralized fashion. A participatory algorithm may be used to negotiate the lowest cost of migration for engine transitions. FIG. 10 shows a flowchart illustrating a method 1000 for selecting a target engine based on cost estimates during a potential engine switch decision process, according to some example embodiments. The method 1000 can be implemented by a system that manages execution of dataframe operations across different engines, such as a hybrid execution framework. For example, the method 1000 can be embodied in machine-readable instructions or machine storage medium for execution by one or more hardware components such that the operations of the method 1000 can be performed by components of the cloud data platform 102, the client environment 116, or other components operably interconnected thereto (see, e.g., FIGS. 5 and 6). It shall be appreciated that method 1000 can be deployed on various other hardware configurations and is not intended to be limited to deployment within the cloud data platform 102. Depending on the embodiment, an operation (or step) of the method 1000 can be repeated in different ways or involve intervening operations not shown. Though the operations of the method 1000 can be depicted and described in a certain order, the order in which the operations are performed may vary among embodiments, including performing certain operations in parallel or performing sets of operations in separate processes. While the various operations in the method 1000 are presented and described sequentially, one of ordinary skill will appreciate that some or all of the operations may be executed in a different order, be combined or omitted, or be executed in parallel.

At step 1002, the system receives a decision about a potential engine switch. This decision is typically triggered by an analysis of workload characteristics, operational requirements, or other factors that indicate the need to evaluate alternative engines for executing specific tasks or operations, as described above.

At step 1004, the system requests cost estimates from potential target engines. These cost estimates may include computational costs, data transfer costs, memory usage, and other resource utilization metrics associated with executing the operations on each engine. Each potential target engine may generate a cost estimate in response to receiving the request. The request may include information regarding the potential engine switch. In some examples, the cost estimates may be scaled using a cost scaler. Therefore, each cost estimate may be a value in a cost scaling range. The system may then receive the cost estimates from the potential target engines.

At step 1006, the system selects the target engine based on the received cost estimates. The selection process involves comparing the cost estimates and identifying the engine that optimally balances performance, resource utilization, and operational efficiency for the given workload. In some embodiments, the costing optimization includes summing up the aggregate execution and data transfer costs to pick the least expensive engine to move data. This optimization can play a significant role when there are multiple dataframes that need to be combined in some way, or if different dataframes reside on different engines and the subsequent operations performed on those dataframes forces the switching of backends.

Described implementations of the subject matter can include one or more features, alone or in combination as illustrated below by way of example.

Example 1 is a method comprising: receiving, by at least one hardware processor, instructions to perform a dataframe operation; analyzing characteristics of the dataframe operation; selecting a first engine to execute a first section of the dataframe operation based on the characteristics; and executing the first section of the dataframe operation on the first engine.

Example 2. The method of example 1, further comprising: selecting a second engine to execute a second section of the dataframe operation based on the characteristics.

Example 3. The method of any of examples 1-2, further comprising: transferring dataframe data to the second engine from the first engine; and executing the second section of the dataframe operation on the second engine.

Example 4. The method of any of examples 1-3, wherein the first engine is a local engine on a client machine and the dataframe data is stored in-memory on the client machine for the execution of the first section of the dataframe operation.

Example 5. The method of any of examples 1-4, wherein the second engine is a cloud platform engine and the dataframe data is stored in a cloud platform associated with the cloud platform engine for the execution of the second section of the dataframe operation.

Example 6. The method of any of examples 1-5, wherein the dataframe is stored in a temporary table in the cloud platform.

Example 7. The method of any of examples 1-6, wherein the characteristics comprise a cost-based function for executing the first section on a plurality of engines.

Example 8. The method of any of examples 1-7, further comprising: transmitting a request for cost estimates to a plurality of engines; and receiving cost estimates from each of the plurality of engines, wherein selection of the first engine is based on the received cost estimates.

Example 9. The method of any of examples 1-8, wherein selecting the first engine is performed by a dataframe application programing interface (API).

Example 10. A system comprising: one or more processors of a machine; and a memory storing instructions that, when executed by the one or more processors, cause the machine to perform operations implementing any one of example methods 1 to 9.

Example 11. A machine-storage medium embodying instructions that, when executed by a machine, cause the machine to perform operations implementing any one of example methods 1 to 9.

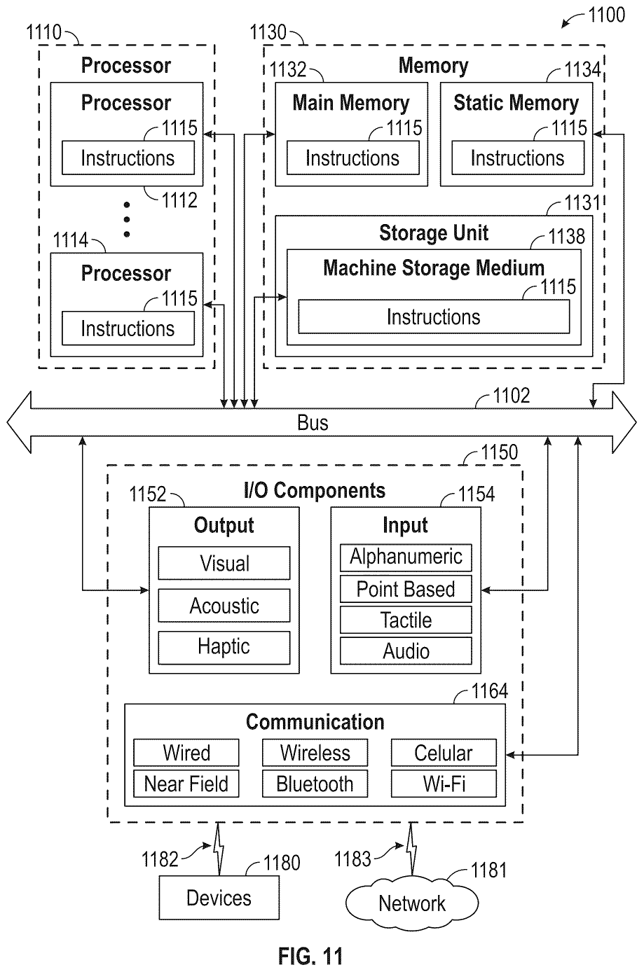

FIG. 11 illustrates a diagrammatic representation of a machine 1100 in the form of a computer system within which a set of instructions may be executed for causing the machine 1100 to perform any one or more of the methodologies discussed herein, according to an example embodiment.

Specifically, FIG. 11 shows a diagrammatic representation of the machine 1100 in the example form of a computer system, within which instructions 1115 (e.g., software, a program, an application, an applet, an app, or other executable code), for causing the machine 1100 to perform any one or more of the methodologies discussed herein (e.g., method 1000 and method 1100), may be executed. For example, the instructions 1115 may cause the machine 1100 to implement portions of the data flows described herein. In this way, the instructions 1115 transform a general, non-programmed machine into a particular machine 1100 (e.g., the client device 114 of FIG. 1, the compute service manager 108 of FIG. 1, the execution platform 110 of FIG. 1) that is specially configured to carry out any one of the described and illustrated functions in the manner described herein.

In alternative embodiments, the machine 1100 operates as a standalone device or may be coupled (e.g., networked) to other machines. In a networked deployment, the machine 1100 may operate in the capacity of a server machine or a client machine in a server-client network environment, or as a peer machine in a peer-to-peer (or distributed) network environment. The machine 1100 may comprise, but not be limited to, a server computer, a client computer, a personal computer (PC), a tablet computer, a laptop computer, a netbook, a smart phone, a mobile device, a network router, a network switch, a network bridge, or any machine capable of executing the instructions 1115, sequentially or otherwise, that specify actions to be taken by the machine 1100. Further, while only a single machine 1100 is illustrated, the term “machine” shall also be taken to include a collection of machines 1100 that individually or jointly execute the instructions 1115 to perform any one or more of the methodologies discussed herein.

The machine 1100 includes processors 1110, memory 1130, and input/output (I/O) components 1150 configured to communicate with each other such as via a bus 1102. In an example embodiment, the processors 1110 (e.g., a central processing unit (CPU), a reduced instruction set computing (RISC) processor, a complex instruction set computing (CISC) processor, a graphics processing unit (GPU), a digital signal processor (DSP), an application-specific integrated circuit (A SIC), tensor processing unit (TPU), a radio-frequency integrated circuit (RFIC), another processor, or any suitable combination thereof) may include, for example, a processor 1112 and a processor 1114 that may execute the instructions 1115. The term “processor” is intended to include multi-core processors 1110 that may comprise two or more independent processors (sometimes referred to as “cores”) that may execute instructions 1115 contemporaneously. Although FIG. 11 shows multiple processors 1110, the machine 1100 may include a single processor with a single core, a single processor with multiple cores (e.g., a multi-core processor), multiple processors with a single core, multiple processors with multiple cores, or any combination thereof.

The memory 1130 may include a main memory 1132, a static memory 1134, and a storage unit 1131, all accessible to the processors 1110 such as via the bus 1102. The main memory 1132, the static memory 1134, and the storage unit 1131 comprise a machine storage medium 1138 that may store the instructions 1115 embodying any one or more of the methodologies or functions described herein. The instructions 1115 may also reside, completely or partially, within the main memory 1132, within the static memory 1134, within the storage unit 1131, within at least one of the processors 1110 (e.g., within the processor's cache memory), or any suitable combination thereof, during execution thereof by the machine 1100.

The I/O components 1150 include components to receive input, provide output, produce output, transmit information, exchange information, capture measurements, and so on. The specific I/O components 1150 that are included in a particular machine 1100 will depend on the type of machine. For example, portable machines, such as mobile phones, will likely include a touch input device or other such input mechanisms, while a headless server machine will likely not include such a touch input device. It will be appreciated that the I/O components 1150 may include many other components that are not shown in FIG. 11. The I/O components 1150 are grouped according to functionality merely for simplifying the following discussion and the grouping is in no way limiting. In various example embodiments, the I/O components 1150 may include output components 1152 and input components 1154. The output components 1152 may include visual components (e.g., a display such as a plasma display panel (PDP), a light emitting diode (LED) display, a liquid crystal display (LCD), a projector, or a cathode ray tube (CRT)), acoustic components (e.g., speakers), other signal generators, and so forth. The input components 1154 may include alphanumeric input components (e.g., a keyboard, a touch screen configured to receive alphanumeric input, a photo-optical keyboard, or other alphanumeric input components), point-based input components (e.g., a mouse, a touchpad, a trackball, a joystick, a motion sensor, or another pointing instrument), tactile input components (e.g., a physical button, a touch screen that provides location and/or force of touches or touch gestures, or other tactile input components), audio input components (e.g., a microphone), and the like.

Communication may be implemented using a wide variety of technologies. The I/O components 1150 may include communication components 1164 operable to couple the machine 1100 to a network 1181 via a coupler 1183 or to devices 1180 via a coupling 1182. For example, the communication components 1164 may include a network interface component or another suitable device to interface with the network 1181. In further examples, the communication components 1164 may include wired communication components, wireless communication components, cellular communication components, and other communication components to provide communication via other modalities. The devices 1180 may be another machine or any of a wide variety of peripheral devices (e.g., a peripheral device coupled via a universal serial bus (USB)). For example, as noted above, the machine 1100 may correspond to any one of the client device(s) 114, the compute service manager 108, and the execution platform 110, and may include any other of these systems and devices.

The various memories (e.g., 1130, 1132, 1134, and/or memory of the processor(s) 1110 and/or the storage unit 1131) may store one or more sets of instructions 1115 and data structures (e.g., software), embodying or utilized by any one or more of the methodologies or functions described herein. These instructions 1115, when executed by the processor(s) 1110, cause various operations to implement the disclosed embodiments.

Another general aspect is for a system that includes a memory comprising instructions and one or more computer processors or one or more hardware processors. The instructions, when executed by the one or more computer processors, cause the one or more computer processors to perform operations. In yet another general aspect, a tangible machine-readable storage medium (e.g., a non-transitory storage medium) includes instructions that, when executed by a machine, cause the machine to perform operations.

As used herein, the terms “machine-storage medium,” “device-storage medium,” and “computer-storage medium” mean the same thing and may be used interchangeably in this disclosure. The terms refer to a single or multiple storage devices and/or media (e.g., a centralized or distributed database, and/or associated caches and servers) that store executable instructions and/or data. The terms shall accordingly be taken to include, but not be limited to, solid-state memories, and optical and magnetic media, including memory internal or external to processors. Specific examples of machine-storage media, computer-storage media, and/or device-storage media include non-volatile memory, including by way of example semiconductor memory devices, (e.g., erasable programmable read-only memory (EPROM), electrically erasable programmable read-only memory (EEPROM), field-programmable gate arrays (FPGA s), and flash memory devices); magnetic disks such as internal hard disks and removable disks; magneto-optical disks; and CD-ROM and DVD-ROM disks. The terms “machine-storage media,” “computer-storage media,” and “device-storage media” specifically exclude carrier waves, modulated data signals, and other such media, at least some of which are covered under the term “signal medium” discussed below.

In various example embodiments, one or more portions of the network 1181 may be an ad hoc network, an intranet, an extranet, a virtual private network (VPN), a local-area network (LAN), a wireless LAN (WLAN), a wide-area network (WAN), a wireless WAN (WWAN), a metropolitan-area network (MAN), the Internet, a portion of the Internet, a portion of the public switched telephone network (PSTN), a plain old telephone service (POTS) network, a cellular telephone network, a wireless network, a Wi-Fi® network, another type of network, or a combination of two or more such networks. For example, the network 1181 or a portion of the network 1181 may include a wireless or cellular network, and the coupling 1182 may be a Code Division Multiple Access (CDMA) connection, a Global System for Mobile communications (GSM) connection, or another type of cellular or wireless coupling. In this example, the coupling 1182 may implement any of a variety of types of data transfer technology, such as Single Carrier Radio Transmission Technology (1×RTT), Evolution-Data Optimized (EVDO) technology, General Packet Radio Service (GPRS) technology, Enhanced Data rates for GSM Evolution (EDGE) technology, third Generation Partnership Project (3GPP) including 3G, fourth generation wireless (4G) networks, Universal Mobile Telecommunications System (UMTS), High-Speed Packet Access (HSPA), Worldwide Interoperability for Microwave Access (WiMAX), Long Term Evolution (LTE) standard, others defined by various standard-setting organizations, other long-range protocols, or other data transfer technology.

The instructions 1115 may be transmitted or received over the network 1181 using a transmission medium via a network interface device (e.g., a network interface component included in the communication components 1164) and utilizing any one of a number of well-known transfer protocols (e.g., hypertext transfer protocol (HTTP)). Similarly, the instructions 1115 may be transmitted or received using a transmission medium via the coupling 1182 (e.g., a peer-to-peer coupling) to the devices 1180. The terms “transmission medium” and “signal medium” mean the same thing and may be used interchangeably in this disclosure. The terms “transmission medium” and “signal medium” shall be taken to include any intangible medium that is capable of storing, encoding, or carrying the instructions 1115 for execution by the machine 1100, and include digital or analog communications signals or other intangible media to facilitate communication of such software. Hence, the terms “transmission medium” and “signal medium” shall be taken to include any form of modulated data signal, carrier wave, and so forth. The term “modulated data signal” means a signal that has one or more of its characteristics set or changed in such a manner as to encode information in the signal.

In some example embodiments, computer-readable files come in several varieties, including unstructured files, semi-structured files, and structured files. These terms may mean different things to different people. Examples of structured files include Variant Call Format (VCF) files, Keithley Data File (KDF) files, Hierarchical Data Format version 5 (HDF5) files, and the like. As known to those of skill in the relevant arts, VCF files are often used in the bioinformatics field for storing, e.g., gene-sequence variations, KDF files are often used in the semiconductor industry for storing, e.g., semiconductor-testing data, and HDF5 files are often used in industries such as the aeronautics industry, in that case for storing data such as aircraft-emissions data.

As used herein, examples of unstructured files include image files, video files, PDFs, audio files, and the like; examples of semi-structured files include JavaScript Object Notation (J SON) files, eXtensible Markup Language (XML) files, and the like. Numerous other example unstructured-file types, semi-structured-file types, and structured-file types, as well as example uses thereof, could certainly be listed here as well and will be familiar to those of skill in the relevant arts. Different people of skill in the relevant arts may classify types of files differently among these categories and may use one or more different categories instead of or in addition to one or more of these.

In the present disclosure, physical units of data that are stored in a cloud data platform—and that make up the content of, e.g., database tables in customer accounts (e.g., customer users)—are referred to as micro-partitions. In different implementations, a cloud data platform can store metadata in micro-partitions as well. The term “micro-partitions” is distinguished in this disclosure from the term “files,” which, as used herein, refers to data units such as image files (e.g., Joint Photographic Experts Group (JPEG) files, Portable Network Graphics (PNG) files, etc.), video files (e.g., Moving Picture Experts Group (M PEG) files, MPEG-4 (MP4) files, Advanced Video Coding High Definition (AVCHD) files, etc.), Portable Document Format (PDF) files, documents that are formatted to be compatible with one or more word-processing applications, documents that are formatted to be compatible with one or more spreadsheet applications, and/or the like. If stored internal to the cloud data platform, a given file is referred to herein as an “internal file” and may be stored in (or at, or on, etc.) what is referred to herein as an “internal storage location.” If stored external to the cloud data platform, a given file is referred to herein as an “external file” and is referred to as being stored in (or at, or on, etc.) what is referred to herein as an “external storage location.”

While example embodiments of the present disclosure reference commands in the standardized syntax of the programming language Structured Query Language (SQL), it will be understood by one having ordinary skill in the art that the present disclosure can similarly apply to other programming languages associated with communicating and retrieving data from a database.

The terms “machine-readable medium,” “computer-readable medium,” and “device-readable medium” mean the same thing and may be used interchangeably in this disclosure. The terms are defined to include both machine-storage media and transmission media. Thus, the terms include both storage devices/media and carrier waves/modulated data signals.

The various operations of example methods described herein may be performed, at least partially, by one or more processors that are temporarily configured (e.g., by software) or permanently configured to perform the relevant operations. Similarly, the methods described herein may be at least partially processor implemented. For example, at least some of the operations of the methods described herein may be performed by one or more processors. The performance of certain of the operations may be distributed among the one or more processors, not only residing within a single machine, but also deployed across a number of machines. In some example embodiments, the processor or processors may be located in a single location (e.g., within a home environment, an office environment, or a server farm), while in other embodiments the processors may be distributed across a number of locations.

Although the embodiments of the present disclosure have been described with reference to specific example embodiments, it will be evident that various modifications and changes may be made to these embodiments without departing from the broader scope of the inventive subject matter. Accordingly, the specification and drawings are to be regarded in an illustrative rather than a restrictive sense. The accompanying drawings that form a part hereof show, by way of illustration, and not of limitation, specific embodiments in which the subject matter may be practiced. The embodiments illustrated are described in sufficient detail to enable those skilled in the art to practice the teachings disclosed herein. Other embodiments may be used and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

Such embodiments of the inventive subject matter may be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art, upon reviewing the above description.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In the appended claims, the terms “including” and “in which” are used as the plain-English equivalents of the respective terms “comprising” and “wherein.” Also, in the following claims, the terms “including” and “comprising” are open-ended; that is, a system, device, article, or process that includes elements in addition to those listed after such a term in a claim is still deemed to fall within the scope of that claim.

Also, in the above Detailed Description, various features can be grouped together to streamline the disclosure. However, the claims cannot set forth every feature disclosed herein, as embodiments can feature a subset of said features. Further, embodiments can include fewer features than those disclosed in a particular example. Thus, the following claims are hereby incorporated into the Detailed Description, with each claim standing on its own as a separate embodiment. The scope of the embodiments disclosed herein is to be determined with reference to the appended claims, along with the full scope of equivalents to which such claims are entitled.

1. A system comprising:
at least one hardware processor; and
at least one memory storing instructions that, when executed by the at least one hardware processor, cause the at least one hardware processor to perform operations comprising:
receiving instructions to perform a dataframe operation;
analyzing characteristics of the dataframe operation, the characteristics comprising a cost based function that estimates a first cost for executing a first section of the dataframe operation and a second cost for executing a second section of the dataframe operation on each of a plurality of engines;
selecting a first engine of the plurality of engines to execute the first section of the dataframe operation based on the characteristics;
selecting a second engine of the plurality of engines to execute the second section of the dataframe operations based on the characteristics, the first engine being a local engine on a client machine and the second engine being a cloud platform engine on a cloud platform; and
executing the first section of the dataframe operation on the first engine and the second section of the dataframe operation on the second engine.

2. (canceled)

3. The system of claim 1, the operations further comprising:
transferring dataframe data to the second engine from the first engine.

4. The system of claim 3, wherein the dataframe data is stored in-memory on the client machine for the execution of the first section of the dataframe operation.

5. The system of claim 4, the dataframe data is stored in the cloud platform associated with the cloud platform engine for the execution of the second section of the dataframe operation.

6. The system of claim 5, wherein the dataframe is stored in a temporary table in the cloud platform.

7. (canceled)

8. The system of claim 1, the operations further comprising:
transmitting a request for cost estimates to the plurality of engines; and
receiving cost estimates from each of the plurality of engines, wherein selection of the first engine is based on the received cost estimates.

9. The system of claim 1, wherein selecting the first engine is performed by a dataframe application programing interface (API).

10. A method comprising:
receiving instructions to perform a dataframe operation;
analyzing characteristics of the dataframe operation, the characteristics comprising a cost based function that estimates a first cost for executing a first section of the dataframe operation and a second cost for executing a second section of the dataframe operation on each of a plurality of engines;
selecting a first engine of the plurality of engines to execute the first section of the dataframe operation based on the characteristics;
selecting a second engine of the plurality of engines to execute the second section of the dataframe operations based on the characteristics, the first engine being a local engine on a client machine and the second engine being a cloud platform engine on a cloud platform; and
executing the first section of the dataframe operation on the first engine and the second section of the dataframe operation on the second engine.

11. (canceled)

12. The method of claim 10, further comprising:
transferring dataframe data to the second engine from the first engine.

13. The method of claim 12, the dataframe data is stored in-memory on the client machine for the execution of the first section of the dataframe operation.

14. The method of claim 13, wherein the dataframe data is stored in the cloud platform associated with the cloud platform engine for the execution of the second section of the dataframe operation.

15. The method of claim 14, wherein the dataframe is stored in a temporary table in the cloud platform.

16. (canceled)

17. The method of claim 10, further comprising:
transmitting a request for cost estimates to the plurality of engines; and
receiving cost estimates from each of the plurality of engines, wherein selection of the first engine is based on the received cost estimates.

18. The method of claim 17, wherein selecting the first engine is performed by a dataframe application programing interface (API).

19. A machine-storage medium embodying instructions that, when executed by a machine, cause the machine to perform operations comprising:
receiving instructions to perform a dataframe operation;
analyzing characteristics of the dataframe operation, the characteristics comprising a cost based function that estimates a first cost for executing a first section of the dataframe operation and a second cost for executing a second section of the dataframe operation on each of a plurality of engines;
selecting a first engine of the plurality of engines to execute the first section of the dataframe operation based on the characteristics;
selecting a second engine of the plurality of engines to execute the second section of the dataframe operations based on the characteristics, the first engine being a local engine on a client machine and the second engine being a cloud platform engine on a cloud platform; and
executing the first section of the dataframe operation on the first engine and the second section of the dataframe operation on the second engine.

20. The machine-storage medium of claim 19, the operations further comprising:
transferring dataframe data to the second engine from the first engine;
wherein the dataframe data is stored in-memory on the client machine for the execution of the first section of the dataframe operation;
wherein the dataframe data is stored in the cloud platform associated with the cloud platform engine for the execution of the second section of the dataframe operation.

21. The system of claim 1, wherein the cost based function accounts for a data transfer cost of transferring dataframe data between the first engine and the second engine.

22. The system of claim 1, wherein the characteristics further comprise a size of a dataset of the dataframe operation, a shape of the dataset, or an operation type of the dataframe operation.

23. The method of claim 10, wherein the cost based function accounts for a data transfer cost of transferring dataframe data between the first engine and the second engine.

24. The method of claim 10, wherein the characteristics further comprise a size of a dataset of the dataframe operation, a shape of the dataset, or an operation type of the dataframe operation.
